(19) United States
(12) Patent Application Publication
(10) Pub. No.: US 2017/0295241 A1
(43) Pub. Date: Oct. 12, 2017

(54) DISPLAY CONTROL DEVICE, IMAGE DISPLAY SYSTEM, AND METHOD FOR CONTROLLING DISPLAY CONTROL DEVICE

(71) Applicant: Sharp Kabushiki Kaisha, Osaka (JP)

(72) Inventor: KEIKO HIRUKAWA, Osaka (JP)

(73) Assignee: Sharp Kabushiki Kaisha, Osaka (JP)

(21) Appl. No.: 15/515,600

(22) PCT Filed: Oct. 1, 2015
(86) PCT No.: PCT/JP2015/077906

§ 371 Date: Mar. 30, 2017

(30) Foreign Application Priority Data
Oct. 1, 2014 (JP) 2014-203419

(51) Int. Cl. H04L 29/08; H04W 4/20; H04B 5/00; H04B 17/27; H04B 17/327; H04M 1/725; H04B 17/23

(52) U.S. Cl. CPC H04L 67/125; H04M 1/7253; H04W 4/206; H04B 17/23; H04B 17/27; H04B 17/327; H04B 5/0062; H04L 67/18; H04M 2250/12; H04M 2250/64; H04W 4/023

(57) ABSTRACT

The present invention achieves an image display that is easily visible to a user, and prevents communication that is not desired by the user. An information processing device (1) includes: a display control section for causing each of one or more images to be displayed in a display section (18) of a display device (11) at a position at which each of display regions in which the respective one or more images are displayed is associated with a corresponding different one of antennas (150).

### TECHNICAL FIELD

The present invention relates to a display control device for causing a display device to display an image.

### BACKGROUND ART

Conventionally, near field communication has been used to transmit/receive information. According to near field communication, information is transmitted/received by bringing a tag reader and a tag into proximity to each other. Patent Literatures 1 to 5 listed below each disclose a technique related to near field communication. For example, Patent Literature 1 discloses, for example, a device that allows a graphic image of (i) a place where a tag provided in a screen is located and (ii) a periphery of the place to be displayed in the screen.

### CITATION LIST

### Patent Literatures

Patent Literature 1

Japanese Patent Application Publication, Tokukai, No. 2009-295075 (Publication date: Dec. 17, 2009)

[Patent Literature 2]

Japanese Patent Application Publication, Tokukai, No. 2011-175626 (Publication date: Sep. 8, 2011)

[Patent Literature 3]

Japanese Patent Application Publication, Tokukai, No. 2009-543495 (Publication date: Dec. 3, 2009)

[Patent Literature 4]

Japanese Patent Application Publication, Tokukai, No. 2000-215278 (Publication date: Aug. 4, 2000) [Patent Literature 5]

Japanese Patent Application Publication, Tokukai, No. 2011-3150 (Publication date: Jan. 6, 2011)

### SUMMARY OF INVENTION

### Technical Problem

According to the technique disclosed in Patent Literature 1, an image indicative of a position of a tag and an image (map) displayed by executing an application are displayed so as to be superimposed. That is, an image that is irrelevant to the application (the image indicative of the position of the tag) is displayed. This makes an image display less easily visible to a user.

By preventing an image indicative of a position of a tag (or a tag reader) from being displayed, it is possible to achieve an image display that is easily visible to a user. Note, however, that this unfortunately makes it impossible for the user to be aware of the image indicative of the position of the tag (or the tag reader). With this, in a case where the user is confused or brings, by mistake, the tag reader (or the tag) into proximity of a tag (or a tag reader) to which the tag reader (or the tag) is not supposed to be brought into proximity, information that is not desired by the user may be acquired and/or a process that is not desired by the user may be carried out.

The present invention has been made in view of the problems, and an object of the present invention is to provide, for example, a display control device that (i) achieves an image display that is easily visible to a user and (ii) prevents communication that is not desired by the user.

### Solution to Problem

In order to attain the object, a display control device in accordance with an aspect of the present invention for causing a display device including: a display section for displaying one or more images; and a near field communication section placed on the display section and having a plurality of antennas via which to externally carry out near field communication to display the one or more images in the display section, the display control device includes: a display control section for causing each of the one or more images to be displayed in the display section at a position at which one of display regions in which the respective one or more images are displayed is designated to correspond to one of the plurality of antennas.

In order to attain the object, an image display system in accordance with an aspect of the present invention includes: a display device including: a display section for displaying one or more images; and a near field communication section placed on the display section and having a plurality of antennas via which to externally carry out near field communication; and a display control device for causing the one or more images to be displayed in the display section of the display device, the display control device causing each of the one or more images to be displayed in the display section at a position at which one of display regions in which the respective one or more images are displayed is designated to correspond to one of the plurality of antennas.

In order to attain the object, a method in accordance with an aspect of the present invention for controlling a display control device for causing a display device including: a display section for displaying one or more images; and a near field communication section placed on the display section and having a plurality of antennas via which to externally carry out near field communication to display the one or more images in the display section; the method includes: a display control step of causing each of the one or more images to be displayed in the display section at a position at which one of display regions in which the respective one or more images are displayed is designated to correspond to one of the plurality of antennas.

### Advantageous Effects of Invention

An aspect of the present invention yields an effect of (i) achieving an image display that is easily visible to a user and (ii) preventing communication that is not desired by the user.

### BRIEF DESCRIPTION OF DRAWINGS

FIG. 1 is a block diagram showing an example of an arrangement of a main part of each of an information processing device, a display device, and a smartphone which are included in an image display system of Embodiment 1.

(a) of FIG. 2 is a front view of an appearance of the display device illustrated in FIG. 1. (b) of FIG. 2 is a side view of an appearance of the display device illustrated in FIG. 1.

(a) through (c) of FIG. 3 are a transition diagram showing an example of a flow of a photograph display process carried out by an information processing device of Embodiment 1. (d) of FIG. 3 schematically illustrates a process carried out subsequently to a process illustrated in (c) of FIG. 3.

FIG. 4 is a flowchart showing an example of a flow of a process carried out in Embodiment 1.

FIG. 5 is a flowchart showing an example of a flow of a photograph display process illustrated in FIG. 4.

FIG. 6 is a transition diagram showing an example of a flow of a menu display process carried out by an information processing device of Embodiment 2.

FIG. 7 is a screen view showing another example of the menu display.

FIG. 8 is a flowchart showing an example of a flow of a process carried out in Embodiment 2.

FIG. 9 is a flowchart showing an example of a flow of a menu display process illustrated in FIG. 8.

FIG. 10 is a screen view showing still another example of the menu display.

FIG. 11 is a transition diagram showing an example of a flow of a process carried out by an information processing device of Embodiment 3.

FIG. 12 is a flowchart showing an example of a flow of a process carried out in Embodiment 3.

FIG. 13 is a transition diagram showing an example of a flow of a process carried out by an information processing device of Embodiment 4.

FIG. 14 is a flowchart showing an example of a flow of a process carried out in Embodiment 4.

FIG. 15 is a screen view showing another example of Embodiment 4.

FIG. 16 is a block diagram showing an example of an arrangement of a main part of each of an information processing device, a display device, and a server which are included in an image display system of Embodiment 5.

FIG. 17 is a flowchart showing an example of a flow of a process carried out in Embodiment 5.

FIG. 18 is a flowchart showing an example of a flow of a display information generating process illustrated in FIG. 17.

FIG. 19 is a block diagram showing an example of an arrangement of a computer that can be used as, for example, the information processing device.

### DESCRIPTION OF EMBODIMENTS

### [Embodiment 1]

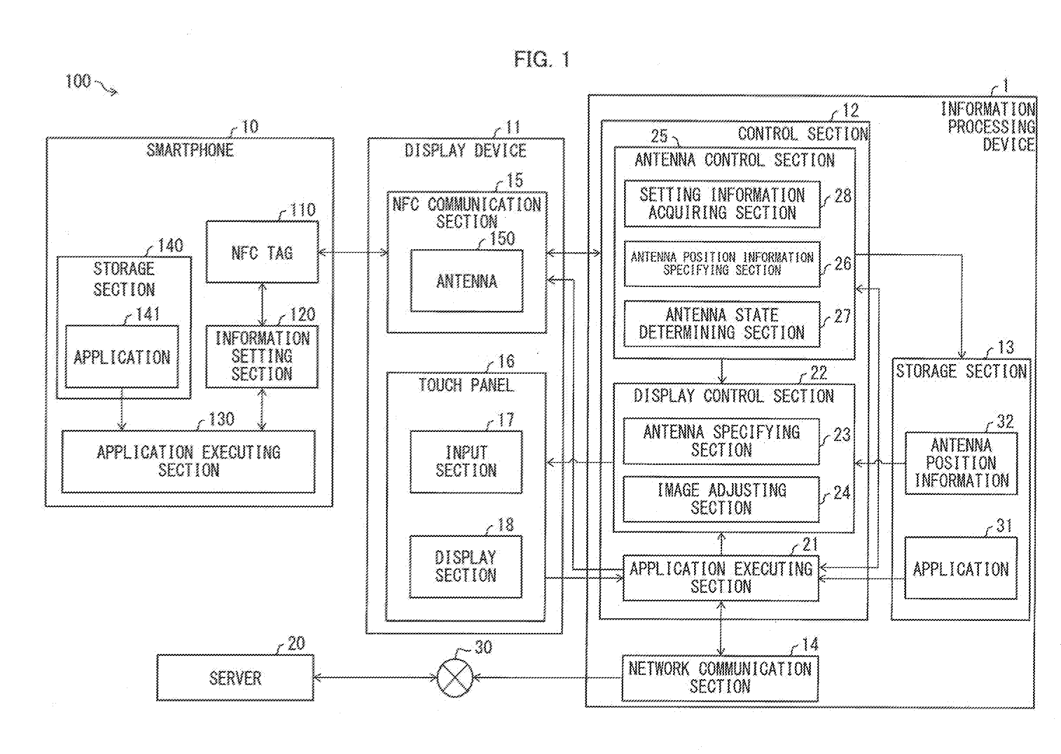

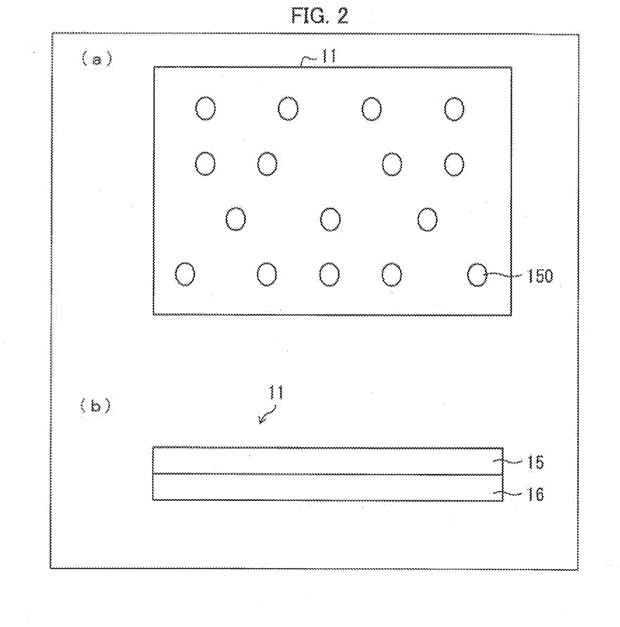

The following description discusses an embodiment of the present invention with reference to FIGS. 1 through 5.

(Image Display System 100)

First, an image display system 100 is described with reference to FIG. 1. FIG. 1 is a block diagram showing an example of an arrangement of a main part of each of an information processing device 1 (display control device), a display device 11, and a smartphone 10 which are included in the image display system 100. Note that the main part of each of the information processing device 1, the display device 11, and the smartphone 10 will be specifically described later.

The display device 11 is a display device for displaying an image in response to an instruction from the information processing device 1. The display device 11, which will be specifically described later, includes a plurality of antennas which is provided in a display region of the display device 11 and via which to externally carry out near field communication. This allows a user to transmit/receive information by bringing a tag (hereinafter referred to as an NFC tag) for NFC into proximity to the display region of the display device 11.

The information processing device 1 causes the display device 11 to display an image. Specifically, the information processing device 1 executes an application and causes the display device 11 to display an image in accordance with a process of the application. Examples of the image include an image such as photograph data (content) stored in a server 20 (described later), a menu image for allowing a user to select a process to be carried out, an image for a Web site that is maintained and operated by the server 20, and the like. Note, however, that the image is not limited to the above examples.

In the example shown in FIG. 1, the information processing device 1 and the display device 11 are illustrated as respective separate devices. Note, however, that the information processing device 1 and the display device 11 can be integrated with each other so as to be a single device. In this case, the information processing device 1 is arranged to include a display corresponding to the display device 11.

The smartphone 10 is a mobile terminal used by a user of the image display system 100. The smartphone 10 includes an NFC tag. This allows the smartphone 10 to carry out near field communication with the display device 11 (the information processing device 1).

The server 20 manages various pieces of information in accordance with an application executed by the information processing device 1. The server 20 transmits various pieces of information to the information processing device 1 via an Internet network 30. For example, the server 20 can be a so-called on-line storage server for keeping data of a user. By executing an application for managing on-line storage, the information processing device 1 allows the display device 11 to display an image (e.g., a photograph) in accordance with data of a user.

(Arrangement of Main Part of Display Device 11)

Next, the following description discusses an arrangement of a main part of the display device 11 with reference to FIGS. 1 and 2. (a) of FIG. 2 is a front view of an appearance of the display device 11. (b) of FIG. 2 is a side view of an appearance of the display device 11.

As illustrated in FIG. 1, the display device 11 includes an NFC communication section 15 (near field communication section) and a touch panel 16.

The NFC communication section 15 is a communication device for externally carrying out near field communication. The NFC communication section 15 includes antennas 150 each sensing an NFC tag and serving as a tag reader for transmitting/receiving information. Specifically, as illustrated in (b) of FIG. 2, the NFC communication section 15 is a sheet member that is placed on the touch panel 16. Note that a positional relationship between the NFC communication section 15 and the touch panel 16 (specifically, an input section 17 and a display section 18, respectively, which are described later) is not limited to that shown in (b) of FIG. 2. For example, the NFC communication section 15 can be provided between the display section 18 and the input section 17 which is provided at the forefront.

Note here that in Embodiment 1 and subsequent Embodiments, the NFC communication section 15 is assumed to have a function of reading/writing data from/into an NFC tag 110 of the smartphone 10. In Embodiment 1 and subsequent Embodiments, reading of data may be referred to as “data reception”, whereas writing of data may be referred to as “data transmission”.

As illustrated in (a) of FIG. 2, the NFC communication section 15 includes the antennas 150. In (a) of FIG. 2, the antennas 150 are randomly provided. Note, however, that the arrangement of the antennas 150 is not limited to this example. For example, the antennas 150 illustrated in (a) of FIG. 2 can be provided at irregular intervals in lines or rows. Alternatively, the antennas 150 can be provided in a matrix pattern.

The touch panel 16 is a member in which the input section 17 and the display section 18 are integrated with each other. Thus, an input region in which the input section 17 receives an input and a display region in which the display section 18 displays an image are substantially identical to each other. The input section 17 receives an operation with respect to the display region in which the display section 18 displays an image.

The input section 17 is an input device which allows a user to input an instruction signal by use of an indicator (finger, pen, etc.). Specifically, the input section 17 includes an input surface for receiving a touch (including an approach) of the indicator, and a touch sensor for sensing not only a touch of the indicator on the input surface but also a position (coordinates) at which the indicator touches the input surface. The touch sensor can be any sensor provided that the sensor can sense a contact/non-contact between the indicator and the input surface. Examples of the touch sensor include a pressure sensor, a capacitive coupling sensor, an optical sensor, and the like. The input section 17 supplies, to an application executing section 21 (described later) of the information processing device 1, information (hereinafter, touch information) regarding a sensed position (coordinates) at which the indicator has touched the input surface. Note that in a case the coordinates at which the indicator has touched the input surface change over time (in a case where a flick operation or a dragging operation is sensed), by regarding, as one piece of touch information, a plurality of sets of coordinates at which sets the indicator touches the input surface and then is separated from the input surface, the input section 17 supplies the plurality of sets of coordinates to the application executing section 21.

The display section 18 is a display device for causing information processed by the information processing device 1 to be displayed as an image in the display region. For example, the display section 18 displays information processed by a display control section 22 (described later) or the like. The display section 18 is constituted by, for example, a liquid crystal display (LCD).

Note that Embodiment 1 describes an example in which the input section 17 and the display section 18 are integrally formed so as to constitute the touch panel 16. Note, however, that an embodiment of the present invention is not limited to this example. That is, the input section 17 and the display section 18 can be respective separate sections, and in this case, the input section 17 serves as an input device such as a mouse or a keyboard.

(Arrangement of Main Part of Information Processing Device 1)

Next, an arrangement of a main part of the information processing device 1 is described below with reference to FIG. 1.

As illustrated in FIG. 1, the information processing device includes a control section 12, a storage section 13, and a network communication section 14.

The control section 12 integratedly controls sections of the information processing device 1. The control section 12 includes the application executing section 21, the display control section 22, and an antenna control section 25.

The application executing section 21 executes various applications stored in the information processing device 1. Specifically, the application executing section 21 carries out a process of an application 31 which has been read from the storage section 13. More specifically, the application executing section carries out a process with respect to the application in accordance with touch information which has been supplied from the input section 17 of the display device 11. Further, the application executing section 21 supplies information of an image to be displayed (image information) to the display control section 22 so that an image in accordance with a process to be carried out is displayed in the display section 18.

Note that an image of Embodiment 1 is an image (etc. photograph) that is in accordance with user's data and is stored in the on-line storage server 20. That is, in order to display the image, the application executing section 21 accesses the server 20 via the network communication section 14 and the Internet network 30, and supplies, to the display control section 22, image information of the image stored in the server 20. Note, however, that the image does not necessarily need to be stored in the server 20 and can be stored in, for example, a storage section 140 of the smartphone 10. In a case where the image is stored in the storage section 140 of the smartphone 10, the application executing section 21 can obtain the image (or image information) by near field communication.

Note also that image information of Embodiment 1 is (i) a data name of an image (etc. photograph) that is stored in the on-line storage server 20, (ii) an address of a folder in the server 20 in which folder the image is stored, and (iii) size information indicative of a size of the image. Note, however, that the image information is not limited to this example. For example, in a case where the image is a photograph, the image information can contain information indicative of, for example, a date and time at which the image was captured. Note that the size information is a length and a width of the image.

The application executing section 21 which has received, from the antenna control section 25, information (setting information) set for the NFC tag 110 of the smartphone 10 and positional information of an antenna 150 via which the information (setting information) has been received specifies an image displayed at a position indicated by the positional information and carries out a process in accordance with the specified image. For example, the application executing section to which setting information has been supplied from the antenna control section 25 carries out a process in accordance with the setting information, or modifies the setting information and transmits the modified setting information to the smartphone 10 via the NFC communication section 15 (antennas 150). Note that the setting information will be specifically described later.

Further, in order to start the application 31 in accordance with the touch information supplied from the input section 17 of the display device 11, the application executing section 21 instructs the antenna control section 25 to specify positional information of the antennas 150 provided in the NFC communication section 15. This realizes a state in which the information processing device 1 retains the positional information of the antennas 150 of the display device 11.

The display control section 22 causes the display section 18 to display an image. The display control section 22 includes an antenna specifying section 23 and an image adjusting section 24. Specifically, in accordance with the image information supplied from the application executing section 21, the display control section 22 causes the display section 18 to display an image. In this case, in order that a display region in which the image is displayed contains an antenna 150 specified by the antenna specifying section 23, the image adjusting section 24 determines a display position of the image and adjusts a size of the image. This process is specifically described below. Note that the following description discusses an example in which a plurality of pieces of image information of a respective plurality of images stored in the server 20 is supplied from the application executing section 21.

The display control section 22 to which the plurality of pieces of image information has been supplied from the application executing section 21 selects one of the plurality of pieces of image information of an image whose display position has not been determined.

The antenna specifying section 23 determines an antenna 150 that is contained in a display region in which an image that is displayed in the display section 18 is displayed. Specifically, the antenna specifying section 23 reads antenna position information 32 (described later) from the storage section 13. Then, with reference to arrangement information of the image which the display control section 22 has caused the display section 18 to display, the antenna specifying section 23 acquires positional information of an antenna 150 that is not contained in a display region in which an image whose display position has been determined is displayed. Subsequently, the antenna specifying section 23 instructs the antenna control section 25 to determine whether the antenna 150 whose positional information has been acquired is in a communication-enabled state in which it is impossible to externally carry out near field communication (the antenna specifying section 23 carries out a process for confirming a state of the antenna 150).

In a case where a result of the determination does not show the communication-enabled state, i.e., in a case where the antenna 150 whose positional information has been acquired is in a communication-disabled state in which it is impossible to carry out near field communication, the antenna specifying section 23 acquires positional information of another antenna 150 that is not contained in the display region in which the image whose display position has already been determined (which has already been arranged) is displayed, and repeats the process for confirming a state of an antenna 150. Note here that the communication-disabled state includes a state in which no electric power is supplied to an antenna 150 (a communication-disabled state in respect of hardware), and a state in which electric power is supplied to an antenna 150 but a function of near field communication carried out via the antenna 150 is stopped (a communication-disabled state in respect of software). Note also that the communication-disabled state in respect of hardware includes a state in which it is impossible to carry out communication via an antenna 150 which malfunctions. Specifically, during the specification of the positional information of the antennas 150, the antenna control section 25 (specifically, an antenna position information specifying section (described later) specifies positional information of the antenna 150 which malfunctions. Then, the antenna control section 25 stops supply of electric power to the antenna 150 which malfunctions. This causes the antenna 150 which malfunctions to be in the communication-disabled state in respect of hardware.

Meanwhile, in a case where the result of the determination shows the communication-enabled state, the antenna specifying section 23 supplies the acquired positional information of the antenna 150 to the image adjusting section 24. Note that hereinafter, an antenna that is different from the antenna 150 whose positional information has been acquired may be referred to as “another antenna 151” so that such an antenna is clearly distinguished from the antenna 150 whose positional information has been acquired.

The image adjusting section 24 determines a position and a size of an image that is displayed in the display section 18. Specifically, in order that a display region in which an image selected by the display control section 22 is displayed contains an antenna 150 whose positional information has been acquired by the antenna specifying section 23, the image adjusting section 24 to which the positional information of the antenna 150 has been supplied from the antenna specifying section 23 determines a display position of the image. Note here that the image adjusting section 24 can set, as a display position of the image, such a position that entirely contains the antenna 150 or such a position that contains only a part of the antenna 150.

The image adjusting section 24 also determines (i) whether the display region in which the image is displayed contains another antenna 151 that is different from the antenna 150 whose positional information has been acquired and that is contained in a display region in which an image that has already been arranged is displayed, and (ii) whether at least a part of the display region in which the image is displayed coincides with a display region in which another image is displayed. Note here that “contains another antenna 151 that is contained in a display region in which an image that has already been arranged is displayed” is an expression that refers to both (a) a case where a display region in which a selected image is displayed entirely contains another antenna 151 that is contained in a display region in which an image that has already been arranged is displayed and (b) a case where the display region in which the selected image is displayed contains only a part of another antenna 151 that is contained in the display region in which an image that has already been arranged is displayed.

Specifically, with reference to the antenna position information 32 acquired from the antenna specifying section 23, the image adjusting section 24 determines whether a display region in which a selected image is displayed entirely contains another antenna 151 that is contained in a display region in which an image that has already been arranged is displayed. Further, with reference to the above-described arrangement information of the image, the image adjusting section 24 determines whether at least a part of the display region in which the selected image is displayed coincides with a display region in which another image is displayed.

In a case where (i) a display region in which a selected image is displayed contains no other antenna 151 that is contained in a display region in which an image that has already been arranged is displayed and (ii) the display region in which the selected image is displayed and a display region in which another image is displayed do not coincide with each other, the display control section 22 causes the selected image to be displayed at a position that has been determined by the image adjusting section 24.

Meanwhile, in a case where a display region in which a selected image is displayed contains another antenna 151 that is contained in a display region in which an image that has already been arranged is displayed, or in a case where at least a part of the display region in which the selected image is displayed coincides with a display region in which another image is displayed, the image adjusting section 24 changes a size of the selected image. Specifically, the image adjusting section 24 reads size information from image information of the selected image and reduces an area of the selected image by reducing a length and a width of the selected image.

Note here that in a case where the selected image contains another antenna 151 that is contained in a display region in which an image that has already been arranged is displayed, the image adjusting section 24 specifies positional information of the another antenna 151 with reference to the antenna position information 32. Then, with reference to the positional information thus specified, the image adjusting section 24 reduces an area of the selected image until the selected image contains no other antenna 151.

In a case where at least a part of a display region in which a selected image is displayed coincides with a display region in which another image is displayed, with reference to the display regions in which the selected image and the another image, respectively, are displayed, the image adjusting section 24 reduces an area of the selected image until the display regions do not overlap with each other.

Note that in order to change a size of an image, while maintaining an aspect ratio of the image, the image adjusting section 24 preferably modifies size information of the image so as to prevent the image from greatly changing in appearance.

After the change in size of the image has been finished, the display control section 22 causes the image to be displayed at a position that has been determined by the image adjusting section 24.

The antenna control section 25 controls the antennas 150 included in the NFC communication section 15. The antenna control section 25 includes the antenna position information specifying section 26, an antenna state determining section 27, and a setting information acquiring section 28.

The antenna position information specifying section 26 specifies positional information of the antennas 150 arranged in the NFC communication section 15. Specifically, the antenna position information specifying section 26 specifies positional information of the antennas 150 in accordance with an instruction from the application executing section 21. The positional information contains (i) coordinate information of a position at which each of the antennas 150 is arranged and (ii) antenna size information indicative of a size of each of the antennas 150. In order to specify positional information of the antennas 150, the antenna position information specifying section 26 specifies positional information of an antenna 150 which malfunctions. Then, as described earlier, the antenna control section 25 stops supply of electric power to the antenna 150 which malfunctions. The antenna position information specifying section 26 which has finished specifying the positional information stores, in the storage section 13, the specified positional information as the antenna position information 32.

Note that as described earlier, the antenna position information 32 can contain information indicative of a position of an antenna 150 to which no electric power is supplied (an antenna 150 which is in the communication-disabled state in respect of hardware). This allows the antenna specifying section 23 to be arranged such that during acquirement of positional information of the antennas 150 from the antenna position information 32, the antenna specifying section 23 acquires no positional information of an antenna 150 which is in the communication-disabled state in respect of hardware.

The antenna state determining section 27 determines whether an antenna 150 is in the communication-enabled state or in the communication-disabled state. Specifically, the antenna state determining section 27 determines, in accordance with an instruction from the display control section 22 (antenna specifying section 23), whether a specified antenna 150 is in the communication-enabled state or in the communication-disabled state. Then, the antenna state determining section 27 supplies a result of the determination to the display control section 22 (antenna specifying section 23).

The setting information acquiring section 28 acquires setting information. Specifically, the setting information acquiring section 28 to which information (setting information) acquired from the NFC tag 110 has been supplied from the NFC communication section 15 supplies, to the application executing section 21, not only the setting information but also positional information of an antenna 150 via which the setting information has been acquired.

The storage section 13 is a storage device for storing various sets of data to be used by the information processing device 1. The storage section 13 at least stores the application 31 and the antenna position information 32.

The application 31 is software to be executed by the application executing section 21. Specifically, the application 31 of Embodiment 1 is an application for managing on-line storage. Note, however, that the application 31 is not limited to this example. Note that a plurality of applications can be stored in the storage section 13.

As described earlier, the antenna position information 32 is information generated by the antenna position information specifying section 26 and indicative of a position (coordinates) and a size of each of the antennas 150. Note that as described earlier, the antenna position information 32 contains positional information of an antenna 150 which malfunctions. Note also that as described earlier, the antenna position information 32 can contain information indicative of a position of an antenna 150 to which no electric power is supplied (an antenna 150 which is in the communication-disabled state in respect of hardware).

The network communication section 14 is a communication device for transmitting/receiving information between the information processing device 1 and an external device (e.g., the server 20) via the Internet network 30.

(Arrangement of Main Part of Smartphone 10)

Next, an arrangement of a main part of the smartphone 10 is described below with reference to FIG. 1. As illustrated in FIG. 1, the smartphone 10 includes the NFC tag 110, an information setting section 120, an application executing section 130, and the storage section 140. The smartphone 10 has functions and members included in a conventional smartphone, such as an input section, a display section, and a communication section. Note, however, that since such members and functions are less relevant to an embodiment of the present invention, a description thereof is omitted here.

The NFC tag 110 is a communication device for externally carrying out near field communication. For the NFC tag 110, it is possible to set information (setting information) that a user desires to transmit externally (e.g., to the information processing device 1). After such information is set, the user brings the smartphone 10 closer to the NFC communication section 15 of the display device 11, so that near field communication is carried out. Then, the setting information set for the NFC tag 110 is transmitted to the information processing device 1 via the display device 11. Further, the NFC tag 110 receives, from the information processing device 1, information transmitted via the NFC communication section 15 of the display device 11.

The information setting section 120 sets setting information for the NFC tag 110. The information setting section 120 sets the setting information for the NFC tag 110 in accordance with an instruction from the application executing section 130. The setting information differs in accordance with an application to be executed by the application executing section 130. In Embodiment 1, the setting information is, for example, a URL indicative of a folder possessed by a user of the smartphone in the on-line storage server 20. Note that the setting information is not limited to this example. For example, the setting information can also be a character string (folder path, URL, or the like) indicative of a specified region (folder) of the storage section 140 of the smartphone 10.

The application executing section 130 executes various applications stored in the smartphone 10. Specifically, the application executing section 130 carries out a process of an application 141 which has been read from the storage section 140. More specifically, in accordance with an instruction from a user via the input section (not illustrated), the application executing section 130 supplies, to the information setting section 120, an instruction to set setting information in accordance with the application 141 which is being executed. Further, the application executing section 130 carries out a process with respect to the application 141 in accordance with the instruction from the user, and causes the display section (not illustrated) of the smartphone 10 to display an image in accordance with the process thus carried out.

The storage section 140 is a storage device for storing various sets of data to be used by the smartphone 10. The storage section 140 at least stores the application 141.

The application 141 is software to be executed by the application executing section 130. Specifically, the application 141 of Embodiment 1 is an application for managing on-line storage. Note, however, that the application 141 is not limited to this example. For example, the application 141 can be an application for browsing a Web site. Note that a plurality of applications can be stored in the storage section 140.

(Specific Example of Process in Accordance with Embodiment 1)

Next, a specific example of a process in accordance with Embodiment 1 is described below with reference to FIG. 3. (a) through (c) of FIG. 3 are a transition diagram showing an example of a flow of a photograph display process carried out by the information processing device 1 of Embodiment 1. (d) of FIG. 3 schematically illustrates a process carried out subsequently to a process illustrated in (c) of FIG. 3.

Embodiment 1 discusses an arrangement in which data possessed by a certain user is acquired, by use of near field communication, by another user, who is different from the certain user. The following description takes, as an example of a specific use case, an arrangement in which a plurality of sets of photograph data possessed by a first user is displayed in the display device 11 and a second user acquires a desired set of photograph data from the displayed plurality of sets of photograph data.

As illustrated in (d) of FIG. 3, Embodiment 1 describes an example in which out of a plurality of sets of photograph data stored in a folder 20a of the first user in the on-line storage server 20 and possessed by the first user, photograph data 171 desired by the second user is copied into a folder 20b of the second user in the server 20. That is, in Embodiment 1, the application executing section 21 of the information processing device 1 manages on-line storage and executes the application 31 for carrying out a process for acquiring photograph data.

First, the application executing section 21 causes the display device 11 to carry out a process for displaying photograph data possessed by the first user. The application executing section 21 starts the application 31 and instructs the antenna control section 25 (specifically, the antenna position information specifying section 26) to specify respective positions of the antennas 150. The antenna position information specifying section 26 specifies respective pieces of positional information and respective sizes of all the antennas 150 arranged in the display device 11, generates the antenna position information 32, and stores the antenna position information 32 in the storage section 13. Subsequently, the application executing section 21 gives the antenna control section 25 an instruction to cause all the antennas 150 to be in the communication-enabled state. As illustrated in (a) of FIG. 3, the antenna control section 25 which has received the instruction causes all the antennas 150, except an antenna that is in the communication-disabled state in respect of software or hardware for some reason, to be in the communication-enabled state.

In a case where the first user brings, in this state, a smartphone 10A of the first user closer to any one of the antennas 150 which are in the communication-enabled state, the one of the antennas 150 acquires setting information from the NFC tag 110 of the smartphone 10A. Hereinafter, in order to distinguish between pieces of setting information, setting information of the smartphone 10A is referred to as first setting information, and setting information of a smartphone 10B is referred to as second setting information. Specifically, the one of the antennas 150 acquires, as the first setting information, information indicative of an account of the first user in an on-line storage service operated by an operator by use of the server 20, and supplies the information to the antenna control section 25 (setting information acquiring section 28) of the information processing device 1. The setting information acquiring section 28 supplies the acquired first setting information to the application executing section 21.

The application executing section 21 carries out a process with respect to the received first setting information. Specifically, the application executing section 21 specifies the account of the first user in the on-line storage service operated by the operator by use of the server 20, and modifies the first setting information so that a process for displaying a list (a content list) of a plurality of sets of photograph data stored in the folder 20a by the first user is carried out. Then, in accordance with the modified first setting information, the application executing section 21 acquires, from the server 20, image information of each of the plurality of sets of photograph data stored in the folder 20a. Thereafter, the application executing section 21 supplies the acquired image information to the display control section 22.

Subsequently, as illustrated in (b) of FIG. 3, the display control section 22 causes the display section 18 to display a list of sets of photograph data. In this case, the list of sets of photograph data is displayed so that one of the antennas 150 is contained in a display region in which one of the sets of photograph data is displayed. Such a process is specifically described below. Note that the arrangement (described earlier) such that one of the antennas 150 is contained in the display region in which one of the sets of photograph data is displayed is merely taken as an example. Alternatively, a plurality of antennas 150 can be arranged to be contained in a display region in which photograph data 175, which is one of the sets of photograph data, is displayed, provided that the plurality of antennas 150 is not contained in the other sets of photograph data. This also applies to the other embodiments. That is, one or more antennas 150 that are not contained in the other sets of photograph data can be contained in a display region in which one image is displayed.

The display control section 22 which has been supplied with the image information selects, from pieces of the image information, one piece of the image information of photograph data whose display position has not been determined. Assume here that image information of the photograph data 171 is selected.

Subsequently, the antenna specifying section 23 reads the antenna position information 32 from the storage section 13 and acquires positional information of an antenna 150 that is not contained in a display region in which photograph data whose display position has been determined is displayed. A method for the acquirement is not particularly limited. Note, however, that according to Embodiment 1, pieces of the positional information are sequentially acquired in a downward direction from upper left of (b) of FIG. 3. Specifically, the antenna specifying section 23 which has been supplied with the image information acquires positional information of an antenna 150A first. Then, subsequently to the acquirement of the positional information of the antenna 150A, the antenna specifying section 23 acquires positional information of an antenna 150B.

Thereafter, the antenna specifying section 23 instructs the antenna control section 25 (specifically, the antenna state determining section 27) to determine whether the antenna 150 whose positional information has been acquired is in the communication-enabled state in which it is possible to externally carry out near field communication. Assume here that a result of the determination shows that the antenna 150 whose positional information has been acquired is in the communication-enabled state. In this case, the antenna specifying section 23 supplies the acquired positional information of the antenna 150 to the image adjusting section 24.

Subsequently, in order that a display region in which selected photograph data is displayed contains the antenna 150 whose positional information has been acquired, the image adjusting section 24 determines a display position of the selected photograph data. Then, the image adjusting section 24 determines (i) whether the display region in which the selected photograph data is displayed contains another antenna that is different from the antenna 150 whose positional information has been acquired and that is contained in a display region in which an image that has already been displayed is displayed, and (ii) whether at least a part of the display region in which the selected photograph data is displayed coincides with a display region in which another photograph data is displayed. Assume here that a result of the determination shows (i) that the selected photograph data contains no other antenna and (ii) that the display region in which the selected photograph data is displayed does not coincide with the display region in which the another photograph data is displayed.

In this case, the display control section 22 causes the photograph data 171 to be displayed at a position that has been determined by the image adjusting section 24. Specifically, the display control section 22 causes the photograph data 171 to be displayed at a position at which the antenna 150A is contained in a display region in which the photograph data 171 is displayed. A process for displaying one set of photograph data is thus ended.

A case where photograph data (an image) is displayed is not limited to an example of the photograph data 171 and the antenna 150A in which example the photograph data 171 is displayed at a position at which the antenna 150A is entirely contained in the display region in which the photograph data 171 is displayed. For example, as in photograph data 173A illustrated in (b) of FIG. 3, photograph data (an image) can also be displayed so that a part of an antenna 150 is contained in a display region in which the photograph data 173A is displayed.

Thereafter, the display control section 22 carries out again a process for selecting one piece of image information of an image whose display position has not been determined. Assume here that image information of photograph data 172 is selected. Then, in accordance with a flow of the process (described earlier), the display control section 22 causes the photograph data 172 to be displayed at a position at which the antenna 150B is contained in a display region in which the photograph data 172 is displayed. The display control section 22 repeats this process until all sets of photograph data are displayed, the antennas 150 are each contained in a display region in which any of the sets of photograph data is displayed, or a region in which photograph data can be displayed no longer exists.

Subsequently, the following description discusses a case where the result of the determination by the image adjusting section 24 shows (i) that a selected image contains another antenna contained in a display region in which photograph data that has already been arranged is displayed, or (ii) that at least a part of the display region in which the selected image is displayed coincides with a display region in which another image is displayed. Specifically, the following description discusses a case where as illustrated in (b) of FIG. 3, a display region in which photograph data 174 is displayed contains another antenna such as the antenna 150B which is contained in the display region in which the photograph data 172 which has already been arranged is displayed and a part of a region of the photograph data 174 coincides with a region of another photograph data. In this case, the image adjusting section 24 acquires size information of the photograph data 174 from image information of the photograph data 174. Then, the image adjusting section 24 reduces the photograph data 174 (reduces a length and a width of the photograph data 174) until the display region in which the photograph data 174 is displayed contains no other antenna such as the antenna 150B which is contained in the display region in which the photograph data which has already been arranged is displayed and a part of the region of the photograph data 174 does not coincide with the region of the another photograph data. In this case, the image adjusting section 24 reduces the photograph data 174 while maintaining an aspect ratio of the photograph data 174. Then, the display control section 22 causes photograph data 174A obtained after the reduction to be displayed.

Note that in a case where the antenna state determining section 27 determines that an antenna 150 is in the communication-disabled state, the antenna specifying section 23 reacquires positional information of another antenna 150. Note here that an antenna 150C illustrated in (b) of FIG. 3 is shown to be in the communication-disabled state in respect of hardware. Specifically, the antenna specifying section 23 which has acquired a result of determination that the antenna 150C is in the communication-disabled state acquires positional information of an antenna 150, which is different from the antenna 150C, out of the antennas 150 each of which is not contained in a display region in which an image whose display position has already been determined is displayed. The arrangement prevents photograph data from being displayed while being superimposed on only an antenna 150 via which it is impossible to carry out near field communication (see (b) of FIG. 3). This makes it possible to avoid a situation in which it is impossible to acquire photograph data that is being displayed.

Note that in a case where the antenna 150C is in the communication-disabled state in respect of hardware as illustrated in (b) of FIG. 3, information indicating that the antenna 150C is in the communication-disabled state can be contained in the antenna position information 32. With the arrangement, without the need to inquire of the antenna state determining section 27 whether the antenna 150C is in the communication-disabled state, the antenna specifying section 23 can specify that the antenna 150C is in the communication-disabled state. In other words, it is possible to achieve an arrangement in which no positional information of the antenna 150C is acquired.

Such a state as illustrated in (b) of FIG. 3 arises when display of photograph data is ended. Note here that as illustrated in (c) of FIG. 3, in a case where the second user brings the smartphone 10B closer to the antenna 150A which is contained in the display region in which the photograph data 171 is displayed, the antenna 150A acquires the second setting information from the NFC tag 110 of the smartphone 10B. Specifically, the antenna 150A acquires, as the second setting information, information indicative of an account of the second user in the on-line storage service operated by an operator by use of the server 20, and supplies the information to the antenna control section 25 (specifically, the setting information acquiring section 28) of the information processing device 1. The setting information acquiring section 28 supplies, to the application executing section 21, not only the acquired second setting information but also positional information of an antenna 150 via which the second setting information has been acquired.

The application executing section 21 carries out a process with respect to the received second setting information. Specifically, the application executing section 21 carries out a process for acquiring the photograph data 171 which is being displayed while being superimposed on the antenna 150A which is indicated by the received positional information. More specifically, the application executing section 21 specifies the account of the second user in the on-line storage service operated by the operator by use of the server 20, modifies the second setting information so that a process for copying the photograph data 171 into the folder 20b of the second user is carried out, and causes the server 20 to carry out the process. With the arrangement, as illustrated in (b) of FIG. 3, the photograph data 171 which is stored in the folder 20a is copied into the folder 20b. That is, the second user can acquire the photograph data 171 which is possessed by the first user.

As described earlier, the information processing device 1 of Embodiment 1 carries out a display so that (i) a selected antenna 150 is contained in a display region in which selected photograph data is displayed and (ii) an antenna 150 contained in a display region in which photograph data which has already been arranged is displayed is not contained in the display region in which the selected photograph data is displayed. Thus, since one set of photograph data is designated to correspond to a certain antenna 150, it is possible to designate one set of photograph data to be obtainable in a case where the smartphone 10 is brought into proximity to an antenna 150. This makes it possible to prevent a misoperation such as obtainment of a photograph that is not desired by a user. Further, since sets of photograph data are displayed so as not to overlap with each other, an image display that is easily visible to a user can be achieved.

(Flow of Process in Accordance with Embodiment 1)

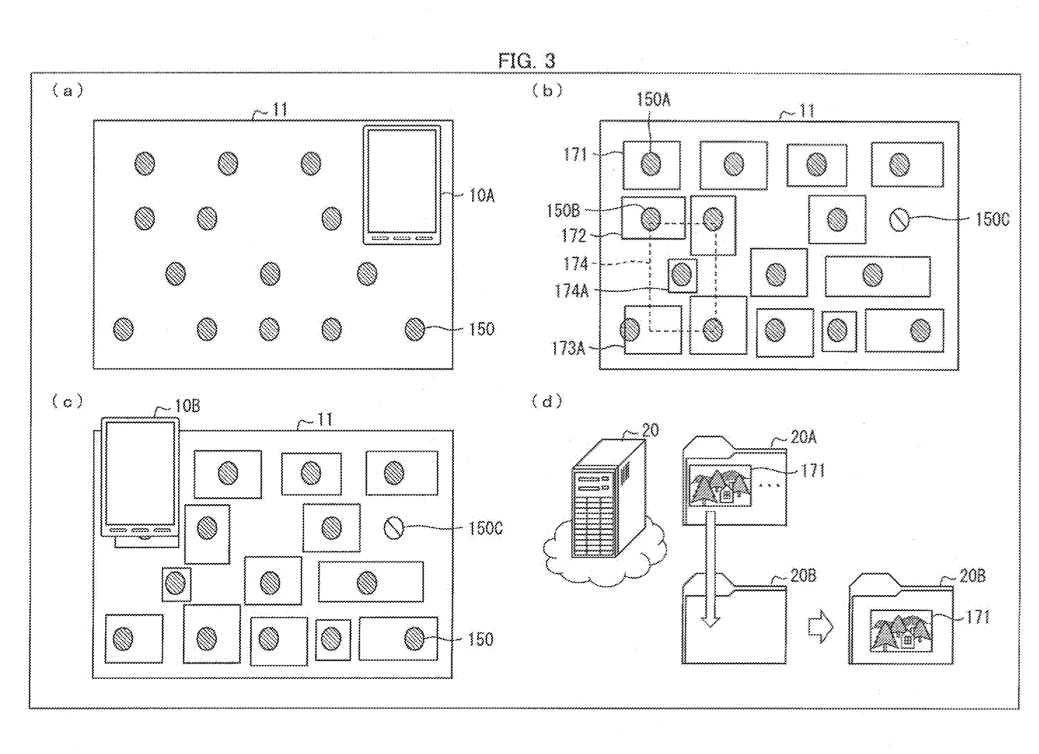

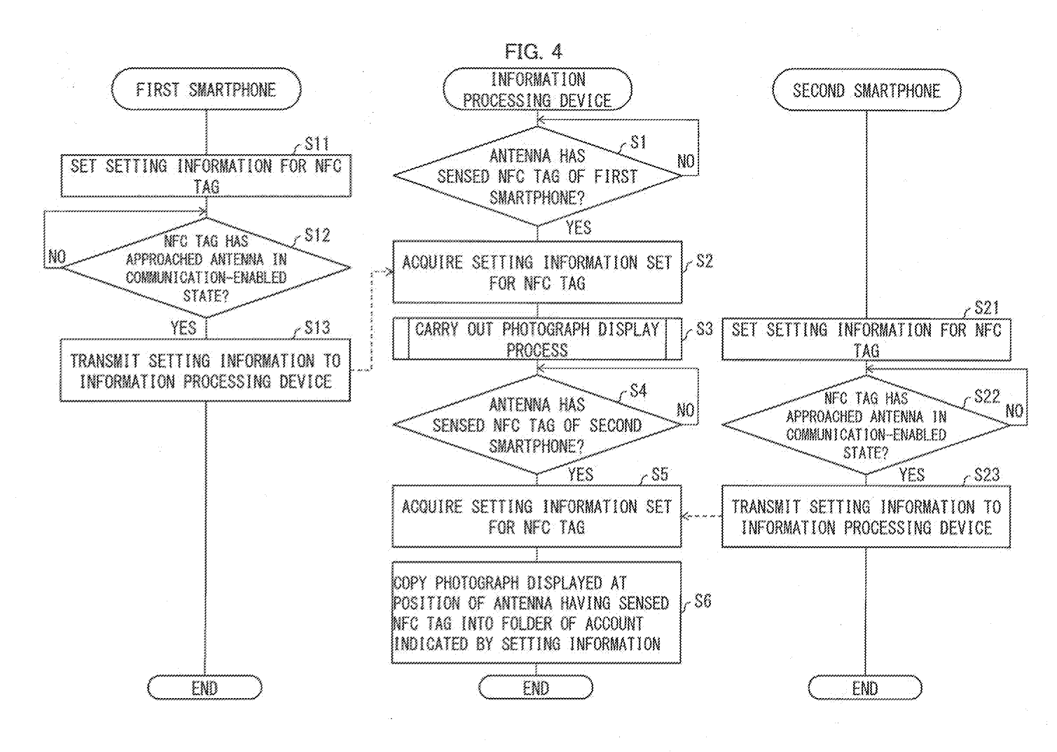

Next, a flow of a process in accordance with Embodiment 1 is described below with reference to FIG. 4. FIG. 4 is a flowchart showing the flow of the process in accordance with Embodiment 1. Note that the following description assumes that the information processing device 1 has already started the application 31 in the flowchart of FIG. 4. That is, the antenna position information 32 has already been stored in the storage section 13, and the antennas 150 are in such a state as illustrated in (a) of FIG. 3.

First, the first user sets the first setting information for the NFC tag 110 of the smartphone 10A of the first user (S11). Specifically, in accordance with an instruction from the application executing section 130, the information setting section 120 sets, for the NFC tag 110, information indicative of the account of the first user in the on-line storage service operated by the operator by use of the server 20. This allows the NFC tag 110 to be capable of transmitting the first setting information by approaching an antenna 150 (S12).

The second user also sets the second setting information for the NFC tag 110 of the smartphone 10B of the second user (S21). Specifically, in accordance with an instruction from the application executing section 130, the information setting section 120 sets, for the NFC tag 110, information indicative of the account of the second user in the on-line storage service operated by the operator by use of the server 20. This allows the NFC tag 110 to be capable of transmitting the second setting information by approaching an antenna 150 (S22).

Meanwhile, the application executing section 21 of the information processing device 1 instructs the antenna control section 25 to cause all the antennas 150 to be in the communication-enabled state (S1). In a case where the NFC tag 110 of the smartphone 10A approaches an antenna 150 which is in the communication-enabled state (YES in S12) and the antenna 150 senses the NFC tag 110 (YES in S1), the first setting information is transmitted from the NFC tag 110 to the information processing device 1 via the antenna 150 (S13). Specifically, the NFC communication section 15 which has acquired the first setting information via the antenna 150 which is in the communication-enabled state transmits the first setting information to the antenna control section 25 (specifically, the setting information acquiring section 28). The setting information acquiring section 28 which has acquired the first setting information (S2) supplies the received first setting information to the application executing section 21.

The application executing section 21 which has acquired the first setting information carries out the photograph display process (S3), and sets of photograph data stored in the folder 20a of the account indicated by the first setting information are displayed so as to correspond to respective positions of the antennas 150. Note that the photograph display process is described later.

Next, in the NFC communication section 15 of the display device 11, an antenna 150 which is in the communication-enabled state is waiting to sense the NFC tag 110 of the smartphone 10B (S4). Note here that in a case where the NFC tag 110 of the smartphone 10B approaches an antenna 150 which is in the communication-enabled state (YES in S22) and the antenna 150 senses the NFC tag 110 (YES in S4), the second setting information is transmitted from the NFC tag 110 to the information processing device 1 via the antenna 150 (S23). Specifically, the NFC communication section 15 which has acquired the second setting information via the antenna 150 which is in the communication-enabled state transmits the second setting information to the antenna control section 25 (specifically, the setting information acquiring section 28). The setting information acquiring section 28 which has acquired the second setting information (S5) not only supplies the received second setting information to the application executing section 21, but also specifies a position of the antenna 150 via which the second setting information has been acquired, and supplies, to the application executing section 21, positional information indicative of the specified position.

The application executing section 21 which has been supplied with the second setting information and the positional information causes the photograph data 175 which is displayed at a position of the antenna 150 which has sensed the NFC tag 110 to be copied into the folder 20b of the account indicated by the second setting information (S6). Specifically, in accordance with the second setting information, the application executing section 21 specifies the account of the second user in the on-line storage service operated by the operator by use of the server 20. Further, the application executing section 21 specifies the photograph data 171 which is displayed at a position indicated by the supplied positional information. Then, the application executing section 21 modifies the second setting information so that a process for copying the photograph data 171 into the folder 20b of the second user is carried out, and causes the server 20 to carry out the process.

(Flow of Photograph Display Process)

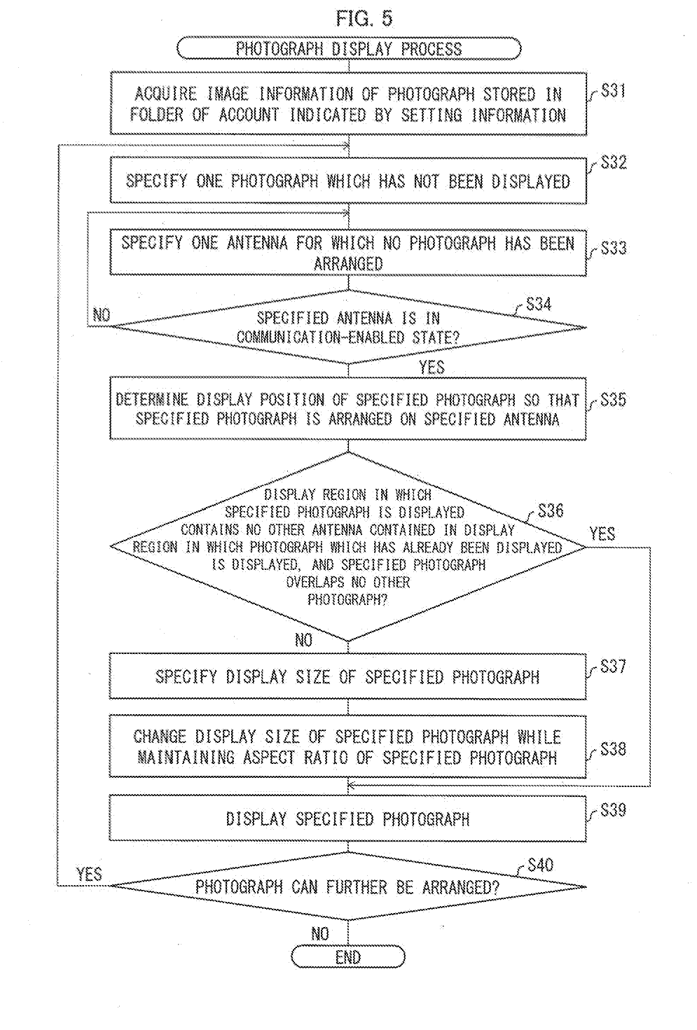

Next, a flow of the photograph display process illustrated in FIG. 4 is described below with reference to FIG. 5. FIG. 5 is a flowchart showing an example of the flow of the photograph display process illustrated in FIG. 4. Note that FIG. 5 shows an example in which a first set of photograph data is displayed in the display section 18 and then a display position of a subsequent set of photograph data is determined. That is, the following description expresses “photograph data which has already been arranged” (described earlier) as “photograph data which has already been displayed”. Note that it is not limited to this example how to determine a display position. For example, it is possible to display photograph data in the display section 18 after determining respective display positions of all sets of the photograph data.

First, the application executing section 21 which has acquired the first setting information acquires image information of photograph data stored in the folder of the account indicated by the first setting information (S31). Specifically, the application executing section 21 specifies the account of the first user in the on-line storage service operated by the operator by use of the server 20, and modifies the first setting information so as to carry out a process for displaying a list of a plurality of sets of photograph data stored by the first user in the folder 20a. Then, in accordance with the modified first setting information, the application executing section 21 acquires, from the server 20, image information of each of the plurality of sets of photograph data stored in the folder 20a. Thereafter, the application executing section 21 supplies the acquired image information to the display control section 22.

Subsequently, the display control section 22 which has been supplied with the image information specifies one set of photograph data which one set has not been displayed (S32). Specifically, the display control section 22 selects, from pieces of the image information, one piece of the image information of photograph data whose display position has not been determined.

Then, the antenna specifying section 23 specifies one antenna 150 for which no photograph data has been arranged (S33). Specifically, the antenna specifying section 23 reads the antenna position information 32 from the storage section 13 and acquires positional information of an antenna 150 that is not contained in a display region in which photograph data whose display position has already been determined is displayed.

Thereafter, the antenna specifying section 23 supplies the acquired positional information of the antenna 150 to the antenna state determining section 27 of the antenna control section 25, and causes the antenna state determining section 27 to determine whether the antenna 150 is in the communication-enabled state (S34). In a case where a result of the determination shows that the antenna 150 is not in the communication-enabled state (NO in S34), the antenna specifying section 23 carries out the step S33 again so as to acquire positional information of another antenna 150.

Meanwhile, in a case where the result of the determination shows that the antenna 150 is in the communication-enabled state (YES in S34), the antenna specifying section 23 supplies, to the image adjusting section 24, positional information of an antenna 150 which has been specified (whose positional information has been acquired). Subsequently, in order that photograph data specified by the display control section 22 is arranged on the specified antenna 150, the image adjusting section 24 determines a display position of the photograph data (S35). Specifically, in order that a display region in which selected photograph data is displayed contains an antenna 150 indicated by the supplied positional information, the image adjusting section 24 determines a display position of the selected photograph data.

Then, the image adjusting section 24 determines (i) whether a display region in which specified photograph data is displayed contains another antenna 151 that is contained in a display region in which photograph data that has already been displayed (arranged) is displayed, and (ii) whether the specified photograph data overlaps another photograph data (S36). Specifically, with reference to the antenna position information 32, the image adjusting section 24 determines whether a display region in which selected photograph data is displayed contains another antenna 151 that is contained in a display region in which photograph data that has already been displayed is displayed. Further, with reference to arrangement information of photograph data, the image adjusting section 24 determines whether at least a part of the display region in which the selected photograph data is displayed coincides with a display region in which another photograph data is displayed.

In a case where the image adjusting section 24 determines (i) that the display region in which the specified photograph data is displayed contains no other antenna 151 that is contained in the display region in which the photograph data that has already been displayed is displayed, and (ii) that the specified photograph data overlaps no other photograph data (YES in S36), the display control section 22 causes the specified photograph data to be displayed (S39). Specifically, the display control section 22 causes photograph data indicated by selected image information to be displayed at a position determined by the image adjusting section 24. Then, the display control section 22 determines whether photograph data can further be arranged (S40). In a case where the display control section 22 determines that photograph data can further be arranged (YES in S40), the photograph display process returns to the step S32. Meanwhile, in a case where the display control section 22 determines that photograph data cannot be arranged (NO in S40), the photograph display process is ended.

In contrast, in a case where the image adjusting section 24 determines (i) that the display region in which the specified photograph data is displayed contains another antenna 151 that is contained in the display region in which the photograph data that has already been displayed is displayed, or (ii) that the specified photograph data overlaps another photograph data (NO in S36), the image adjusting section 24 specifies a display size of the specified photograph data (S37). Specifically, the image adjusting section 24 specifies image information of selected photograph data and acquires size information of the selected photograph data. Then, the image adjusting section 24 changes the display size of the specified photograph data while maintaining an aspect ratio of the specified photograph data (S38). Specifically, in a case where a display region in which the selected photograph data is displayed contains another antenna 151 that is contained in the display region in which the photograph data that has already been displayed is displayed, with reference to the antenna position information 32, the image adjusting section 24 reduces the selected photograph data until the display region in which the selected photograph data is displayed contains no other antenna 151 that is contained in the display region in which the photograph data that has already been displayed is displayed. Meanwhile, in a case where the selected photograph data overlaps another photograph data, with reference to display regions in which the selected photograph data and the another photograph data, respectively, are displayed, the image adjusting section 24 reduces the selected photograph data until the display regions do not overlap with each other. Note that in a case where (i) the display region in which the selected photograph data is displayed contains the another antenna 151 that is contained in the display region in which the photograph data that has already been displayed is displayed, and (ii) the selected photograph data overlaps the another photograph data, the image adjusting section reduces the selected photograph data until the two requirements (described earlier) are met.

Finally, the display control section 22 causes the specified photograph data to be displayed (S39). Specifically, the display control section 22 causes photograph data indicated by selected image information (reduced photograph data) to be displayed at a position determined by the image adjusting section 24. Then, the display control section 22 determines whether photograph data can further be arranged (S40). In a case where the display control section 22 determines that photograph data can further be arranged (YES in S40), the photograph display process returns to the step S32. Meanwhile, in a case where the display control section 22 determines that photograph data cannot be arranged (NO in S40), the photograph display process is ended.

Note that the information processing device 1 in accordance with Embodiment 1 does not transmit, to the smartphone 10, a response to setting information received from the smartphone 10. Thus, in Embodiment 1 near field communication can be carried out by use of, for example, (i) a smartphone provided with an RF tag and (ii) a display device provided with an RF tag reader. This also applies to Embodiments 3 and 4 (described later).

The information processing device 1 in accordance with Embodiment 1 is arranged to adjust a position and a size of photograph data. Note, however, that what of the photograph data is adjusted is not limited to this example. For example, it is also possible to adjust an orientation of the photograph data. Specifically, in a case where photograph data whose width indicated by size information of the photograph data is larger than its length indicated by the size information is arranged as it is and an edge of the photograph data passes through another antenna 151 or overlaps another photograph data, the image adjusting section 24 can carry out a process for replacing, with each other, the width and the length, which are indicated by the size information.

The description of Embodiment 1 takes photograph data as an example of content of a content list that is displayed in the display device 11 (specifically, the display section 18). Note, however, that the content of the content list is not limited to photograph data. For example, the content can be exemplified by a coupon image that is maintained and managed by the smartphone 10 and/or the server 20, an image indicative of various electronic payment options, and an image indicative of a character and/or an item of a game. Alternatively, the content can also be a thumbnail image indicative of a moving image, audio, an application, and/or the like.

### Embodiment 2

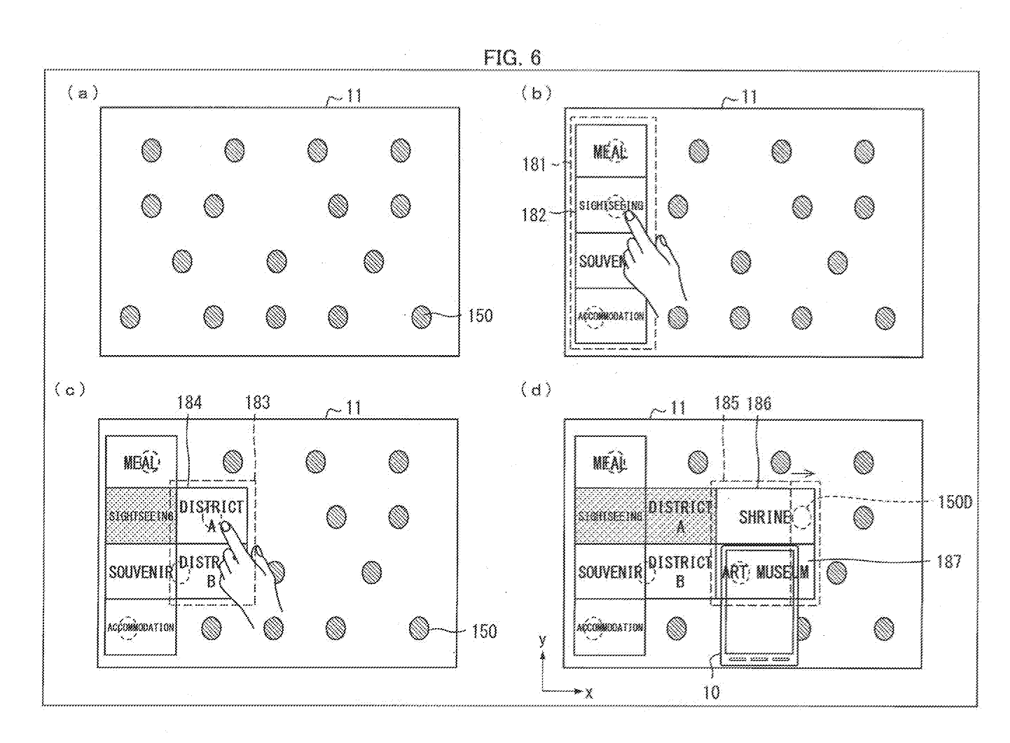

The following description discusses another embodiment of the present invention with reference to FIGS. 6 through 10. Note that, for convenience of explanation, identical reference numerals are given to constituent members having functions identical with those of the constituent members described in Embodiment 1, and descriptions of such constituent members are omitted here.

(Specific Example of Process in Accordance with Embodiment 2)

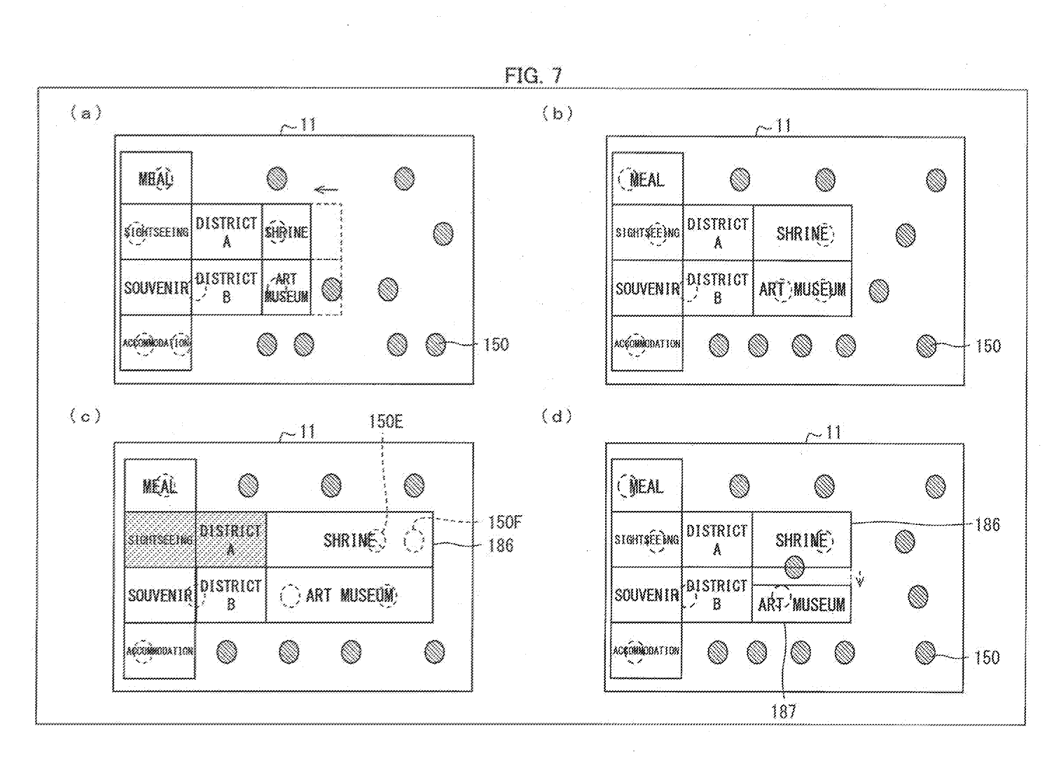

First, the following description discusses a specific example of a process in accordance with Embodiment 2 with reference to FIGS. 6 and 7. FIG. 6 is a transition diagram showing an example of a flow of a menu display process carried out by the information processing device 1 of Embodiment 2. FIG. 7 is a screen view showing another example of the menu display.

Embodiment 2 discusses an arrangement in which a URL for a Web page is supplied from the information processing device 1 to the smartphone 10 by use of near field communication. The following description takes, as a specific use case, an arrangement in which in a case where the smartphone 10 is brought into proximity to a specific item in a menu image displayed on the display device 11 in response to a user operation, a URL for a Web page indicated by the specific item is transmitted to the smartphone 10. Note that the above use case is just one example that shall not limit the present invention. For example, the Web page can be replaced by a Web application.

In Embodiment 2, the application executing section 21 of the information processing device 1 executes an application 31 for tourist information, and causes the display device 11 to display an image related to the application 31.

First, the application executing section 21, as in Embodiment 1, starts the application 31 and instructs the antenna control section 25 (specifically, the antenna position information specifying section 26) to specify respective positions of the antennas 150. The antenna position information specifying section 26 specifies respective pieces of positional information and respective sizes of all the antennas 150 arranged in the display device 11, generates the antenna position information 32, and stores the antenna position information 32 in the storage section 13. Subsequently, the application executing section 21 gives the antenna control section 25 an instruction to cause all the antennas 150 to be in the communication-enabled state. As illustrated in (a) of FIG. 6, the antenna control section 25 which has received the instruction causes all the antennas 150 to be in the communication-enabled state.

Then, the application executing section 21 supplies, to the display control section 22, a script of a menu image for allowing the user to select any of the content items, and also instructs the display control section 22 to display a new layer of the menu image. Here, the script defines display positions and display sizes of individual items in the menu image. With reference to the script thus supplied, the display control section 22 specifies a first layer 181 to be displayed. Then, the image adjusting section 24 determines whether any of character strings representing the individual items of the first layer 181 contains communication specification information indicating that near field communication is carried out via any of the antennas 150. Specifically, the image adjusting section 24 specifies one yet-to-be-displayed item contained in the first layer 181 and determines whether a character string for displaying the specified item contains communication specification information (e.g., a data tag). Here, the character strings representing the individual items of the first layer 181 are assumed to contain no communication specification information. In other words, even in a case where the smartphone 10 is brought into proximity to positions where the individual items of the first layer 181 are displayed, near field communication is not carried out. In this case, the display control section 22 displays the first layer 181 in accordance with the script as illustrated in (b) of FIG. 6.

Subsequently, the user is assumed to have carried out a touch operation with respect to an item 182 marked “SIGHTSEEING”. In accordance with touch information supplied from the input section 17, the application executing section 21 instructs the display control section 22 to display a new layer of the menu image. In response to the instruction, the display control section 22 refers to the script so as to specify a second layer 183 to be displayed. Then, the image adjusting section 24 determines, as in the determination made for the first layer 181, whether character strings representing individual items of the second layer 183 contain communication specification information indicating that near field communication is carried out via any of the antennas 150. Assume here that none of the character strings representing the individual items of the second layer 183 contain the communication specification information. In this case, the display control section 22 displays the second layer 183 in accordance with the script as illustrated in (c) of FIG. 6.

Subsequently, the user is assumed to have carried out a touch operation with respect to an item 184 marked “DISTRICT A”. In accordance with touch information supplied from the input section 17, the application executing section 21 instructs the display control section 22 to display a new layer of the menu image. The display control section 22 refers to the script so as to specify a third layer 185 to be displayed. Then, with reference to the script, the image adjusting section 24 determines, as in the determination made for the first layer 181 and the second layer 183, whether character strings representing individual items of the third layer 185 contain communication specification information indicating that near field communication is carried out via any of the antennas 150. Assume here that the character strings representing the individual items of the third layer 185 contain the communication specification information.

In this case, with reference to the script, the image adjusting section 24 specifies a character string representing an yet-to-be-displayed item out of the items contained in the third layer 185. Note here that the image adjusting section 24 has specified a character string representing an item 186.

Subsequently, the image adjusting section 24 instructs the antenna specifying section 23 to acquire position information of an antenna 150. The antenna specifying section 23 reads antenna position information 32 from the storage section 13 to acquire the positional information of the antenna 150 that is not contained in a display region in which an item whose display position has already been determined is displayed. In so doing, in order that a layout of the menu image is not seriously disarranged, it is preferable that the antenna specifying section 23 determine an antenna 150 whose position information is to be acquired. Therefore, the image adjusting section 24 instructs the antenna specifying section 23 to acquire positional information and also supplies, to the antenna specifying section 23, a requirement (antenna acquirement requirement) as described below. Specifically, in a case where an XY plane is defined as illustrated in (d) of FIG. 3, the image adjusting section 24 causes upper left coordinates of the item 186 illustrated in (d) of FIG. 6 to coincide with upper right coordinates of the item 184 and causes lower left coordinates of the item 186 to coincide with lower right coordinates of the item 184. Besides, the image adjusting section 24 causes the upper right coordinates and lower right coordinates of the item 186 to be variable in an X-axis direction (note, however, that X of each of the upper left coordinates and the lower left coordinates <X of each of the upper right coordinates and the lower right coordinates). In this case, the image adjusting section 24 supplies, to the antenna specifying section 23, a requirement that an antenna 150 which can be contained in a display region determined by the above four sets of coordinates of the item 186 is to be acquired. The antenna specifying section acquires positional information of the antenna 150 that satisfies the above antenna acquirement requirement (the antenna 150D in the example shown in (d) of FIG. 6).

Note that, in a case where the antenna 150 which satisfies the above antenna acquirement requirement is absent, with reference to the script, the antenna specifying section 23 acquires positional information of the antenna 150 which is present near a display region in which the item 186 is displayed. Note, however, that this is not the only process to be carried out in the case where the antenna 150 which satisfies the above antenna acquirement requirement is absent.

Thereafter, the antenna specifying section 23 instructs the antenna control section 25 (the antenna state determining section 27) to determine whether the antenna 150D whose positional information has been acquired is in the communication-enabled state in which it is possible to externally carry out near field communication. Assume here that a result of the determination shows that the antenna 150D whose positional information has been acquired is in the communication-enabled state. In this case, the antenna specifying section 23 supplies the positional information of the antenna 150D to the image adjusting section 24. Note that a case where the result of the determination shows that the antenna 150D whose positional information has been acquired is not in the communication-enabled state will be described later.

The image adjusting section 24 which has been supplied with the positional information of the antenna 150D changes a width of the item 186 (specifically, a length of the item 186 in the X-axis direction) so that the display region in which the item 186 is displayed contains the antenna 150D whose positional information has been acquired. Specifically, the image adjusting section 24 nullifies a script-defined width of the item 186 and instead increases the width of the item 186 so that the display region in which the item 186 is displayed contains the antenna 150D. In this example, the width of the item 186 is increased so that the display region in which the item 186 is displayed entirely contains the antenna 150D. Alternatively, a width of a selected item can be increased so that the display region in which the selected item is displayed contains only a part of the antenna 150.

Note, however, that in a case where the width of the item 186 is the one such that the display region in which the item 186 is displayed contains only a part of the antenna 150 (for example, the antenna 150D in (d) of FIG. 6), the antenna 150D is contained both in the display region in which the item 186 is displayed and in a display region in which an item provided on the right side of the item 186 is displayed. Therefore, in a case where images (images of, for example, items) are displayed in contact with each other as in Embodiment 2, it is preferable that the width of a selected image be determined so that the selected image entirely contains the antenna 150 whose positional information has been acquired.

Subsequently, the image adjusting section 24 determines whether the display region in which the item 186 is displayed contains another antenna 151 that is different from the antenna 150D whose positional information has been acquired and that is contained in a display region in which an item that has already been arranged is displayed. Specifically, with reference to the antenna position information 32 acquired from the antenna specifying section 23, the image adjusting section 24 determines whether a display region in which a selected image is displayed entirely contains another antenna 151 that is contained in a display region in which an item that has already been arranged is displayed. Assume here that a result of the determination shows that the another antenna 151 is not contained in the display region in which the item 186 is displayed.

In this case, the display control section 22 displays the item 186 which has been subjected to a change in width. Meanwhile, a process carried out in a case where the result of the determination has shown that the another antenna 151 is contained in the display region in which the item 186 is displayed will be described later.

Note that the image adjusting section 24 can also determine whether at least a part of the display region in which the item 186 is displayed coincides with a display region in which another item is displayed. Note, however, that in Embodiment 2, in which the menu image whose display state has been determined by the script is displayed, it is hard to consider that the display region in which the item 186 is displayed coincides with a display region in which another item is displayed. Therefore, an example in which such determination is omitted is discussed here.

Thereafter, with reference to the script, the image adjusting section 24 repeats the process for specifying a character string that represents an yet-to-be-displayed item out of the items contained in the third layer 185. Embodiment 2 specifies a character string for displaying an item 187, carries out a process similar to the above process carried out for the item 186, and then displays the item 187 that has been subjected to that process. Note that, in order not to seriously disarrange the layout of the menu image, it is preferable that a width of the item 187 be made identical to the width of the item 186 (see (d) of FIG. 6). That is, unless a display region in which the item 187 is displayed contains the antenna 150 contained in the display region in which the item 186 is displayed, the image adjusting section 24 changes the width of the item 187 to a width identical to the width of the item 186.

In a case where the smartphone 10 is brought into proximity to an item as illustrated in (d) of FIG. 3 after the third layer 185 has been displayed, a URL for a Web page of an institution indicated by the item (a Web page of an art museum in the example shown in (d) of FIG. 3) is transmitted to the smartphone 10. This allows the user to use the smartphone 10 to browse a Web page of an institution in which the user is interested. Note that, in view of easiness of understanding, (d) of FIG. 3 shows the characters “ART MUSEUM”, which is supposed to be hidden by the smartphone 10.

As discussed above, in Embodiment 2, a size (width) of an item containing the communication specification information, i.e., an item that can be subjected to near field communication by being brought into proximity to the smartphone 10, is adjusted so that a display region in which such an item is displayed contains at least one antenna 150. FIG. 6 shows an example in which an item having a width larger than the script-defined width is displayed. Note, however, a width of an item is not limited to this example provided that the width allows a display region in which the item is displayed to contain at least one antenna 150. For example, as illustrated in (a) of FIG. 7, an item having a width smaller than the script-defined width can be displayed. Alternatively, as illustrated in (b) of FIG. 7, in order that the layout of the menu image is not seriously disarranged, an item can have a width that allows a display region in which the item is displayed to contain two or more antennas 150.

Further alternatively, as illustrated in (c) of FIG. 7, in a case where the antenna state determining section 27 has determined that the antenna 150E specified by the antenna specifying section 23 is in the communication-disabled state, the antenna specifying section 23 acquires positional information of another antenna 151 that prevents the layout of the menu image from being seriously disarranged. Specifically, as illustrated in (c) of FIG. 7, the antenna specifying section 23 specifies positional information of an antenna 150F. Then, in a case where the antenna 150F is in the communication-enabled state, the antenna specifying section 23 supplies, to the image adjusting section 24, positional information of the antenna 150F. The image adjusting section 24 changes the width of the item 186 so that the display region in which the item 186 is displayed entirely contains the antenna 150F.

Further, in a case where the result of the determination by the image adjusting section 24 shows that another antenna 151 contained in a display region in which an item that has already been arranged is displayed is contained in a display region in which a selected item is displayed, the image adjusting section 24 changes a size of the selected item. Specifically, with reference to the positional information of the another antenna 151, the image adjusting section 24 reduces the size of the selected item until the display region in which the selected item is displayed does not contain the another antenna 151. For example, as illustrated in (d) of FIG. 7, the image adjusting section 24 decreases a height of the item 187 (a length, extending in a Y-axis direction, of the item illustrated in (d) of FIG. 6). It is preferable that the size be changed so that the layout of the menu image is not seriously disarranged. Note, however, that the height of the item 187 is not limited to this provided that such a change is impossible. For example, as illustrated in (d) of FIG. 7, the item 186 and the item 187 can have different heights.

(Flow of Process in Accordance with Embodiment 2)

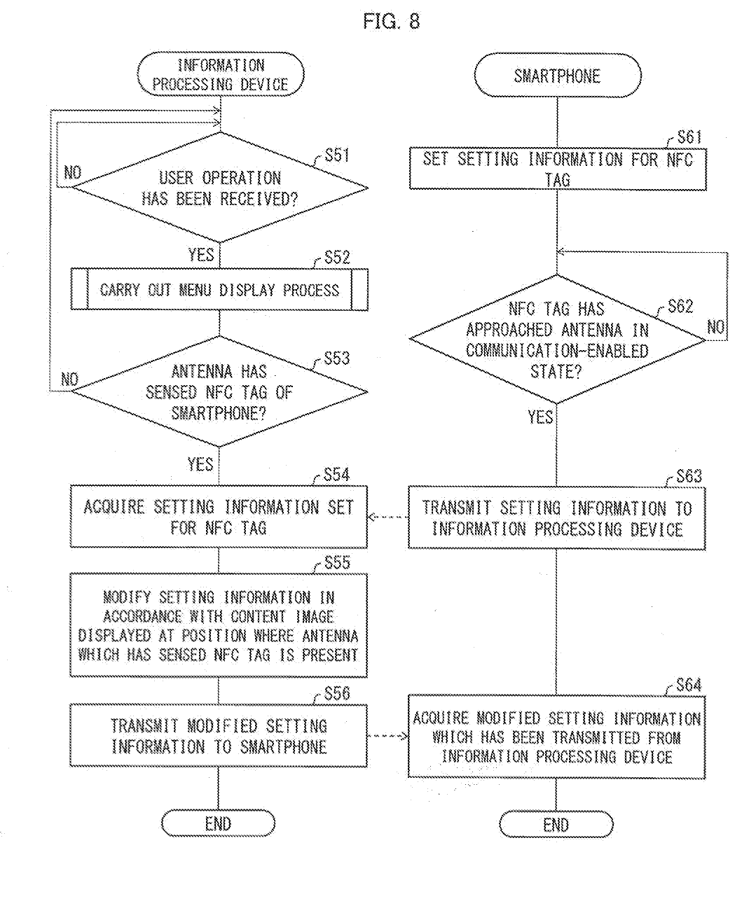

Next, a flow of a process in accordance with Embodiment 2 is described below with reference to FIG. 8. FIG. 8 is a flowchart showing a flow of a process in accordance with Embodiment 2. Note that the following description assumes that, in the flowchart of FIG. 8, the information processing device 1 has already started the application 31, and the first layer 181 has already been displayed in response to a touch operation carried out by the user. That is, the antenna position information 32 has already been stored in the storage section 13, and how displayed images and the antennas 150 are located in the display section 18 is as illustrated in (b) of FIG. 6.

First, the user sets setting information for an NFC tag 110 of his/her own smartphone 10 (S61). Specifically, in accordance with an instruction given by an application executing section 130, the information setting section 120 sets, for the NFC tag 110, setting information illustrated in (b) of FIG. 4. This causes the NFC tag 110 to be in a state in which the NFC tag 110 is capable of transmitting the setting information in a case where the NFC tag 110 is brought into proximity to any of the antennas 150 which are in the communication-enabled state (S62).

Meanwhile, the application executing section 21 of the information processing device 1 is in a state of waiting to receive, via the input section 17 of the display device 11, touch information indicative of a position at which the user carries out a touch operation (S51). In a case where touch information is received (YES in S51), specifically, in a case where touch information indicative of a touch on any content in the first layer 181 is received, the application executing section 21 instructs the display control section 22 to display a new layer of the menu image in accordance with the touch information supplied from the input section 17. In response to the instruction, the display control section 22 carries out the menu display process (S52). The menu display process will be described later.

As a result of the menu display process, in the NFC communication section 15 of the display device 11, an antenna 150 which is in the communication-enabled state is waiting to sense the NFC tag 110 of the smartphone 10 (S53). Note here that in a case where the NFC tag 110 approaches the antenna 150 which is in the communication-enabled state (YES in S62) and the antenna 150 senses the NFC tag 110 (YES in S53), the setting information is transmitted from the NFC tag 110 to the information processing device 1 via the antenna 150 (S63). Specifically, the NFC communication section 15 which has acquired the setting information via the antenna 150 which is in the communication-enabled state transmits the setting information to the antenna control section 25 (specifically, the setting information acquiring section 28). The setting information acquiring section 28 which has acquired the setting information (S54) not only supplies the received setting information to the application executing section 21, but also specifies a position of the antenna 150 via which the setting information has been acquired, and supplies, to the application executing section 21, positional information indicative of the specified position. Note, here, that the setting information transmitted from the smartphone 10 is a character string (folder path, URL, or the like) that represents a specific region (folder) in the storage section 140 of the smartphone 10.

The application executing section 21 which has been supplied with the setting information and the positional information modifies the setting information in accordance with an item displayed at a position at which the antenna which has sensed the NFC tag 110 is present (S55). Specifically, the application executing section 21 specifies the item 187 displayed at a position indicated by the supplied positional information. The application executing section 21 then modifies the setting information by using a URL for a Web page (for example, a Web page of an art museum) associated with the specified item 187. Specifically, the application executing section 21 modifies the setting information by adding the description of the URL for the Web page of the art museum subsequent to a character string indicative of a folder in the smartphone 10. This makes it possible to browse the Web page of the art museum in an application (application for browsing Web sites) of the smartphone 10.

Subsequently, the application executing section 21 transmits, to the smartphone 10, the setting information thus modified (S56). Specifically, the application executing section 21 transmits the setting information thus modified, to the smartphone 10 by near field wireless communication via the NFC communication section 15. The smartphone 10 then acquires the above modified setting information which has been transmitted by near field wireless communication from the information processing device 1 (specifically, the application executing section 21) (S64).

This allows the user to browse, on the smartphone 10, the Web page associated with the item which has been displayed at the position at which the antenna 150 which the smartphone 10 approaches is located.

(Flow of Menu Display Process)

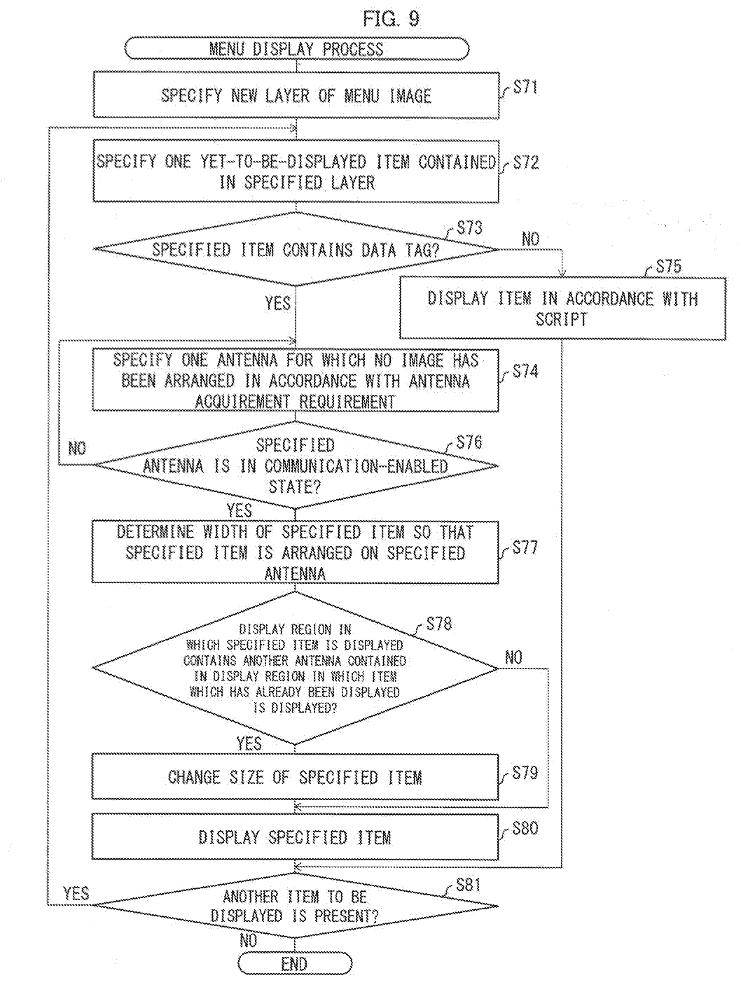

Next, a flow of the menu display process illustrated in FIG. is described below with reference to FIG. 9. FIG. 9 is a flowchart showing an example of a flow of the menu display process illustrated in FIG. 8. Note that FIG. 8 shows an example arrangement in which one item is displayed in the display section 18, and then a display position of another item is determined. That is, the following description expresses “item that has already been arranged” (described earlier) as “item that has already been displayed”. Further, the menu display process is not limited to the example shown in FIG. 8. For example, it is possible to display the items on the display section 18 after determining respective display positions of all the items.

First, with reference to the script supplied from the application executing section 21, the display control section 22 specifies the second layer 183 to be displayed (S71). Then, with reference to the script, the image adjusting section 24 specifies one yet-to-be-displayed item contained in the second layer 183 thus specified (S72). Subsequently, the image adjusting section 24 specifies whether the specified item contains a data tag, i.e., communication specification information indicating that near field communication is carried out via any of the antennas 150 (S73). Note here that none of the items of the second layer 183 contain the communication specification information as described earlier. In a case where the specified item does not contain the data tag (NO in S73), the display control section 22 displays the specified item in accordance with the script (S75). Then, the display control section 22 determines whether another item to be displayed is present (S81). In a case where another item to be displayed is present (YES in S81), the step S72 is carried out again. Meanwhile, in a case where another item to be displayed is absent (NO in S81), the menu display process is ended.

Next, the following description discusses an example case where the third layer 185 is displayed. Note that in the following description, the steps S71 and S72 are carried out similarly except that the second layer 183 is replaced by the third layer 185. Thus, a description of the steps S71 and S72 is omitted below.

The image adjusting section 24 specifies whether the specified item contains a data tag, i.e., communication specification information indicating that near field communication is carried out via any of the antennas 150 (S73). Note here that the items of the third layer 185 contain the communication specification information as described earlier. In a case where the items of the third layer 185 contain the communication specification information (YES in S73), the image adjusting section 24 instructs the antenna specifying section 23 to acquire positional information of an antenna 150 and supplies the antenna acquirement requirement to the antenna specifying section 23.

The antenna specifying section 23 specifies, in accordance with the antenna acquirement requirement, one antenna 150 for which no image has been arranged (S74). Specifically, the antenna specifying section 23 acquires positional information of the antenna 150 that satisfies the aforementioned antenna acquirement requirement. Then, the antenna specifying section 23 determines whether the specified antenna 150 is in the communication-enabled state (S76). Specifically, the antenna specifying section 23 instructs the antenna state determining section 27 to determine whether the antenna 150 whose positional information has been acquired is in the communication-enabled state in which it is possible to externally carry out near field communication. In a case where a result of the determination shows that the antenna 150 whose positional information has been acquired is not in the communication-enabled state (NO in S76), the antenna specifying section 23 carries out the step S74 again to acquire positional information of another antenna 150 that satisfies the antenna acquirement requirement.

Meanwhile, in a case where the result of the determination shows that the antenna 150 whose positional information has been acquired is in the communication-enabled state (YES in S76), the antenna specifying section 23 supplies, to the image adjusting section 24, positional information of the antenna 150 which has been specified (whose positional information has been acquired). Subsequently, in order that an item specified by the display control section 22 is arranged on the specified antenna 150, the image adjusting section 24 determines a width of the specified item (S77). Specifically, the image adjusting section 24 changes the width of the specified item so that a display region in which the specified item is displayed contains the antenna 150 whose positional information has been acquired.

Subsequently, the image adjusting section 24 determines whether the display region in which the specified item is displayed contains another antenna 151 that is contained in a display region in which an item that has already been displayed is displayed (S78). Specifically, with reference to the antenna position information 32 acquired from the antenna specifying section 23, the image adjusting section 24 determines whether the display region in which the specified item is displayed contains another antenna 151 that is different from the antenna 150 whose positional information has been acquired and that is contained in the display region in which the item that has already been displayed is displayed. In a case where the display region in which the specified item is displayed does not contain another antenna 151 that is contained in the display region in which the item that has already been displayed is displayed (NO in S78), the display control section 22 displays the specified item (S80). Specifically, the display control section 22 displays the item whose width has been changed by the image adjusting section 24. Then, the display control section 22 determines whether another item to be displayed is present (S81). In a case where the display control section 22 determines that another item to be displayed is present (YES in S81), the process returns to the step S72. Meanwhile, in a case where the display control section 22 determines that another item to be displayed is absent (NO in S81), the menu display process is ended.

In contrast, in a case where the display region in which the specified item is displayed contains another antenna 151 that is contained in the display region in which the item that has already been displayed is displayed (YES in S78), the image adjusting section 24 changes a size of the specified item (S79). Specifically, with reference to the antenna position information 32, the image adjusting section 24 changes a size of the specified item until the display region in which the specified item is displayed does not contain the another antenna 151 that is contained in the display region in which the item that has already been displayed is displayed.

Finally, the display control section 22 displays the specified item (S80). Specifically, the display control section 22 displays the item whose size has been changed by the image adjusting section 24. Then, the display control section 22 determines whether another item to be displayed is present (S81). In a case where the display control section 22 determines that another item to be displayed is present (YES in S81), the process returns to the step S72. Meanwhile, in a case where the display control section 22 determines that another item to be displayed is absent (NO in S81), the menu display process is ended.

(Variations of Embodiment 2)

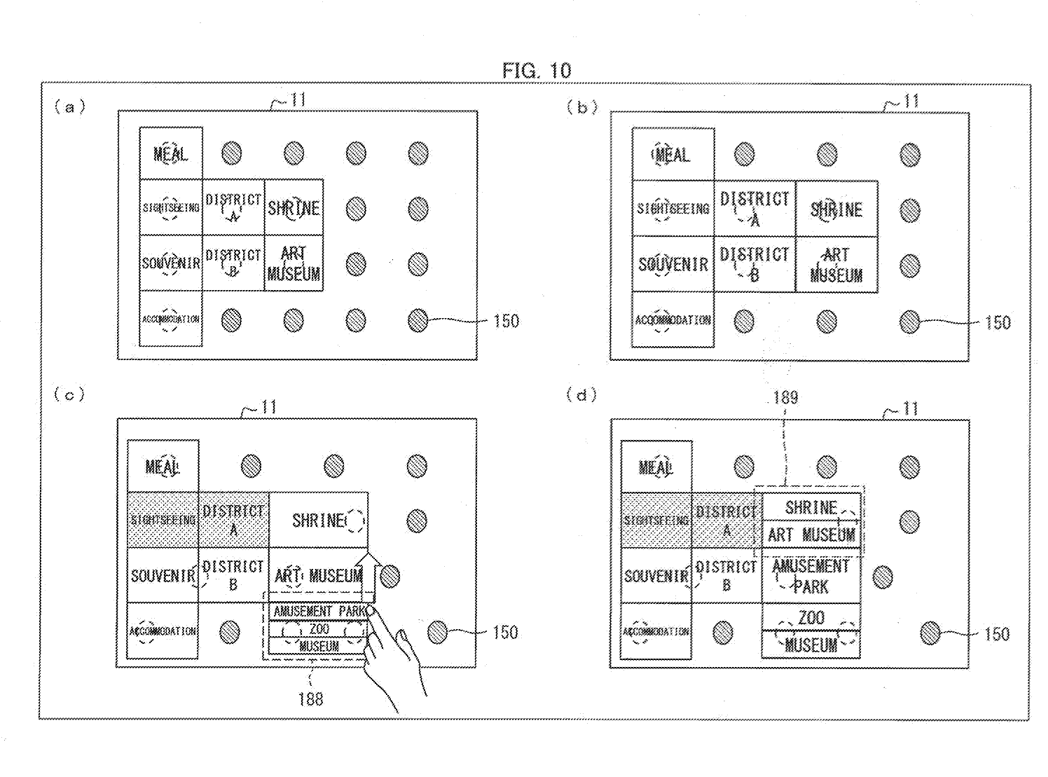

Next, the following description discusses variations of Embodiment 2 with reference to FIG. 10. FIG. 10 is a screen view showing still another example of the menu display.

In Embodiment 2, an item that does not contain the communication specification information such as a data tag is displayed in a predetermined size in accordance with the script. However, all the items, regardless of whether each of the items contains the communication specification information, can be arranged such that a display region in which each of the items is displayed contains at least one antenna 150 and a size of each of the items is changed so that a display region in which one of the items is displayed does not contain another antenna that is contained in a display region in which another one of the items which one has already been displayed is displayed.

Specifically, as illustrated in (a) of FIG. 10, an example arrangement can be employed in which all the items each contain one antenna 150 and are each displayed in a size that prevents a display region in which one of the items is displayed from containing another antenna that is contained in a display region in which another one of the items which one has already been displayed is displayed. That is, the size of each of the items is determined depending upon positions of the antennas specified by the antenna position information 32 and a space between the respective antennas. For example, a space between the respective antennas 150 in the example arrangement illustrated in (b) of FIG. 10 is larger than that in the example arrangement illustrated in (a) of FIG. 10. In this case, a width of each of the items in the example arrangement illustrated in (b) of FIG. 10 is accordingly larger than that in the example arrangement illustrated in (a) of FIG. 10.

Further, in a case where a large number of items are contained in one layer, some items (“AMUSEMENT PARK”, “ZOO”, and “MUSEUM”) can be grouped and displayed in a form of an item group 188 as illustrated in (c) of FIG. 10. This makes it possible to display all the items in the display section 18. Note that the example arrangement illustrated in (c) of FIG. 10 assumes that even in a case where character strings for displaying the individual items in the item group 188 contain the communication specification information, near field communication cannot be carried out. In this case, the application executing section 21 which has acquired touch information indicative of an upward flick operation with respect to the display position of the item group 188 instructs the display control section 22 to change the display to a display as illustrated in (d) of FIG. 10. That is, the items marked “SHRINE” and “ART MUSEUM” are grouped into an item group 189, and the item marked “AMUSEMENT PARK” is displayed as a single item. In a case where an item is displayed as a single item, such an item contains one antenna 150 and is displayed in a size that prevents a display region in which that item is displayed from containing another antenna 151 that is contained in a display region in which an item that has already been displayed is displayed. In this case, the item marked “AMUSEMENT PARK” can be subjected to near field communication. That is, by carrying out a flick operation to display one of grouped items as a single item, the user can carry out near field communication with respect to a desired item.

### Embodiment 3

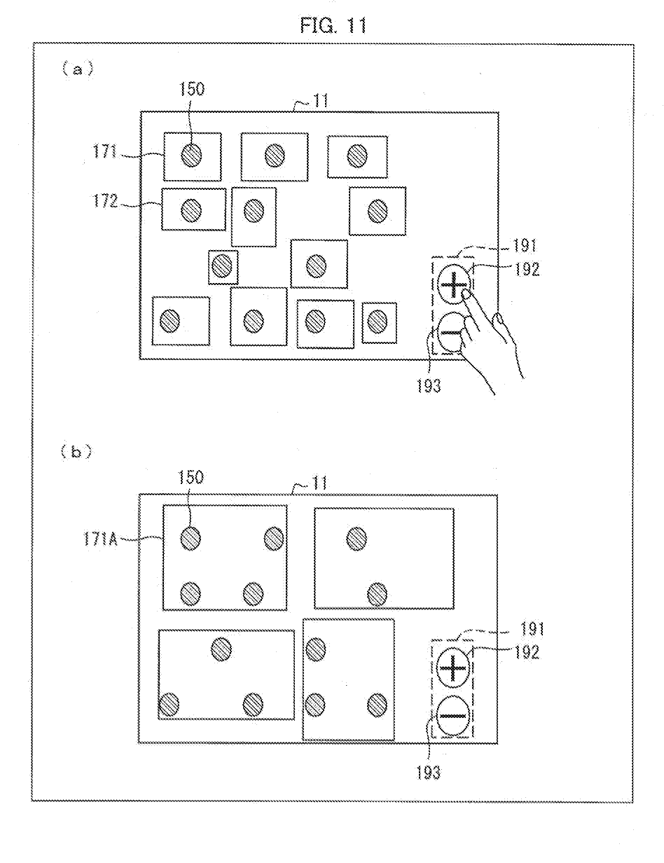

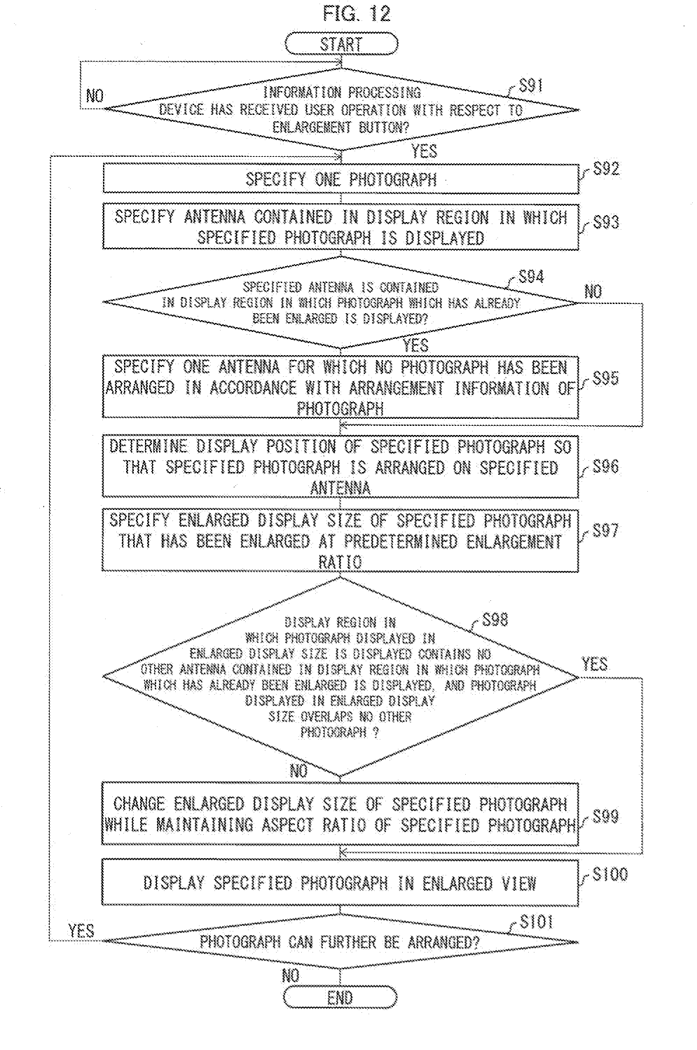

The following description discusses still another embodiment of the present invention with reference to FIGS. 11 and 12. Note that, for convenience of explanation, identical reference numerals are given to constituent members having functions identical with those of the constituent members described in Embodiments 1 and 2, and descriptions of such constituent members are omitted here.

(Specific Example of Process in Accordance with Embodiment 3)

First, the following description discusses a specific example of a process in accordance with Embodiment 3 with reference to FIG. 11. FIG. 11 is a transition diagram showing an example of a flow of a process carried out by the information processing device 1 of Embodiment 3.

Embodiment 3 discusses a process in which a part of a display region of the display device 11 is enlarged or reduced in the arrangement, which is discussed in Embodiment 1 and in which a list of sets of photograph data is displayed in the display device 11 (display section 18).

As illustrated in (a) of FIG. 11, the display control section 22 causes each of sets of photograph data to be displayed in such a manner that a display region in which each of sets of photograph data is displayed contains one antenna 150, and does not contain another antenna 151 that is contained in a display region in which photograph data that has already been arranged is displayed. In other words, sets of photograph data and the antennas 150 are in one-to-one correspondence.

Here, as illustrated in (a) of FIG. 11, an enlargement/reduction button group 191 including an enlargement button 192 and a reduction button 193 is displayed in the display device 11.

In a case where the user touches the enlargement button 192, the application executing section 21 acquires touch information indicative of a touch on the enlargement button 192 and then instructs the display control section 22 to carry out an enlargement process.

In response to the instruction to carry out the enlargement process, the display control section 22 displays a part of a display region of the display section 18 (in this example, an upper left part illustrated in (a) of FIG. 11) in an enlarged view. In this case, each of sets of photograph data is displayed in an enlarged view. In so doing, the image adjusting section 24 enlarges each of the sets of photograph data so that a display region in which each of the sets of photograph data is displayed does not contain an antenna that is contained in a display region in which photograph data that has already been enlarged is displayed. For example, as illustrated in (b) of FIG. 11, each of sets of photograph data is enlarged so that each of the antennas 150 is contained in only a display region in which any one of sets of photograph data is displayed. In this example, photograph data 171 illustrated in (a) of FIG. 11 is enlarged into photograph data 171A illustrated in (b) of FIG. 11. As a result of the enlargement, a display region in which the photograph data 171A is displayed contains four antennas as illustrated in (b) of FIG. 11.

This causes each of the antennas 150 to correspond to any of sets of photograph data. Thus, in a case where the smartphone 10 is brought into proximity to any of the antennas 150, it is possible to specify which set of photograph data the smartphone 10 is attempting to acquire.

Note that it is possible to provide an antenna 150 that is not contained in any of display regions in which respective sets of photograph data are displayed. Note, however, that such an arrangement may confuse the user. This is because no process is carried out in a case where the user brings the smartphone 10 into proximity to that antenna 150. Therefore, it is preferable that each of sets of photograph data be enlarged so that all the antennas 150 are each contained in any of display regions in which respective sets of photograph data are displayed.

In the example shown in (b) of FIG. 11, all the antennas 150 are each contained entirely in any of display regions in which respective sets of photograph data are displayed. Note, however, that photograph data can be enlarged so that the antennas 150 are each partially contained in any of display regions in which respective sets of photograph data are displayed.

(Flow of Process in Accordance with Embodiment 3)

Next, a flow of a process in accordance with Embodiment 3 is described below with reference to FIG. 12. FIG. 12 is a flowchart showing a flow of a process in accordance with in Embodiment 3. Note that in Embodiment 3, a process in which near field communication is carried out between the smartphone 10 and the information processing device 1 is similar to the process illustrated in FIG. 4, which has been described in Embodiment 1. Therefore, FIG. 12 omits a description of the process for carrying out near field communication.

First, the application executing section 21 of the information processing device 1 is in a state of waiting to receive, via the input section 17 of the display device 11, touch information indicative of a position at which the user carries out a touch operation (S91). Note here that the application executing section 21 which has received an operation carried out by the user with respect to the enlargement button 192 (YES in S91), specifically, the application executing section 21 which has acquired touch information indicative of a touch of the enlargement button 192 instructs the display control section 22 to carry out the enlargement process.

In response to the instruction, the display control section 22 specifies one set of photograph data (S92). Specifically, the display control section 22 selects one set of photograph data (for example, the photograph data 171 illustrated in (a) of FIG. 11) from among a plurality of sets of photograph data displayed, and then specifies image information of the selected photograph data.

Subsequently, the antenna specifying section 23 specifies an antenna 150 contained in a display region in which the photograph data specified by the display control section 22 is displayed (S93). Specifically, with reference to arrangement information of unenlarged photograph data and the antenna position information 32, the antenna specifying section 23 specifies positional information of the antenna 150 contained in the display region in which the photograph data 171 is displayed.

Subsequently, the antenna specifying section 23 determines whether the specified antenna 150 is contained in a display region in which photograph data that has already been enlarged is displayed (S94). Specifically, with reference to arrangement information of the photograph data that has already been enlarged and the antenna position information 32, the antenna specifying section 23 specifies whether the photograph data that has already been enlarged is displayed so that the specified antenna 150 is contained in the display region in which the photograph data that has already been enlarged is displayed.

In a case where the antenna specifying section 23 determines that the antenna 150 is not contained in the display region in which the photograph data that has already been enlarged is displayed, the antenna specifying section 23 supplies, to the image adjusting section 24, positional information of that antenna 150, i.e., the antenna 150 contained in the display region in which the selected photograph data 171 is displayed.

Meanwhile, the antenna specifying section 23 determines that the antenna 150 is contained in the display region in which the photograph data that has already been enlarged is displayed, the antenna specifying section 23 specifies, in accordance with the arrangement information of photograph data, one antenna 150 for which no photograph data has been arranged (S95). Specifically, with reference to the arrangement information of the photograph data that has already been enlarged, the antenna specifying section 23 specifies image information (specifically, data name) of photograph data that is displayed so that the antenna 150 specified in the step S93 is contained in the display region in which the photograph data is displayed. Subsequently, with reference to the arrangement information of the unenlarged photograph data, the antenna specifying section 23 specifies a positional relationship between the selected photograph data 171 and specified enlarged photograph data. Then, with reference to the positional relationship thus specified, the antenna specifying section 23 specifies one antenna 150 for which no enlarged photograph data has been arranged.

Assume, for example, that the specified enlarged photograph data is photograph data into which the photograph data 172 illustrated in (a) of FIG. 11 has been enlarged. In this case, since the photograph data 171 is displayed above the photograph data 172 in (a) of FIG. 11, the antenna specifying section 23 specifies, on an upper side of a display region in which the photograph data 172 that has been enlarged is displayed, one antenna 150 for which no photograph data has been arranged.

Then, the antenna specifying section 23 supplies, to the image adjusting section 24, positional information of the antenna 150 thus specified.

Subsequently, in order that the photograph data specified by the display control section 22 is arranged on the specified antenna 150, the image adjusting section 24 determines a display position of the photograph data (S96). Specifically, in order that a display region in which the selected photograph data 171 is displayed contains the antenna 150 indicated by the supplied positional information, the image adjusting section 24 determines a display position of the photograph data 171.

Then, the image adjusting section 24 specifies an enlarged display size of the specified photograph data that has been subjected to enlargement at a predetermined enlargement ratio (S97). Specifically, a degree of the enlargement ratio at which enlargement is carried out in response to a touch on the enlargement button 192 is predetermined, and information indicative of the enlargement ratio is stored in, for example, the storage section 13 (not illustrated). The image adjusting section 24 acquires size information from the image information of the photograph data 171 and then multiplies a length and a width by the enlargement ratio so as to specify an enlarged display size.

Thereafter, the image adjusting section 24 determines (i) whether a display region in which photograph data displayed in the enlarged display size is displayed contains another antenna 151 contained in a display region in which photograph data that has already been enlarged is displayed and (ii) whether the photograph data displayed in the enlarged display size overlaps another photograph data (S98). Specifically, with reference to the antenna position information 32, the image adjusting section 24 determines whether a display region in which selected photograph data is displayed contains another antenna 151 that is contained in a display region in which photograph data that has already been enlarged is displayed. Further, with reference to arrangement information of enlarged photograph data, the image adjusting section 24 determines whether at least a part of the display region in which the selected photograph data is displayed coincides with a display region in which the another photograph data is displayed.

In a case where the image adjusting section 24 determines (i) that the display region in which the photograph data displayed in the enlarged display size is displayed contains no other antenna 151 that is contained in the display region in which the photograph data that has already been enlarged is displayed, and (ii) that the photograph data displayed in the enlarged display size overlaps no other photograph data (YES in S98), the display control section 22 causes the specified photograph data to be displayed in an enlarged view (S100). Specifically, the image adjusting section 24 enlarges the photograph data 171 at a predetermined enlargement ratio. Then, the display control section 22 displays, at the display position determined by the image adjusting section 24, enlarged photograph data (specifically, the photograph data 171A illustrated in (b) of FIG. 11). Then, the display control section 22 determines whether photograph data can further be arranged (S101). In a case where the display control section 22 determines that photograph data can further be arranged (YES in S101), the photograph display process returns to the step S92. Meanwhile, in a case where the display control section 22 determines that photograph data cannot further be arranged (NO in S101), the photograph display process is ended.

In contrast, in a case where the image adjusting section 24 determines (i) that the display region in which the photograph data displayed in the enlarged display size is displayed contains another antenna 151 that is contained in the display region in which the photograph data that has already been enlarged is displayed, or (ii) that the photograph data displayed in the enlarged display size overlaps the another photograph data (NO in S98), the image adjusting section 24 changes the enlarged display size of the specified photograph data while maintaining an aspect ratio of the specified photograph data (S99). Specifically, in a case where a display region in which the photograph data displayed in the enlarged display size is displayed contains the another antenna 151 that is contained in the display region in which the photograph data that has already been enlarged is displayed, with reference to the antenna position information 32, the image adjusting section 24 reduces the enlarged display size of the photograph data until the display region in which the photograph data displayed in the enlarged display size is displayed contains no other antenna 151 that is contained in the display region in which the photograph data that has already been enlarged is displayed. Meanwhile, in a case where the photograph data displayed in the enlarged display size overlaps the another photograph data, with reference to display regions in which the photograph data displayed in the enlarged display size and the another photograph data, respectively, are displayed, the image adjusting section 24 reduces the enlarged display size of the photograph data until the display regions do not overlap with each other. Note that in a case where (i) the display region in which the photograph data displayed in the enlarged display size is displayed overlaps the another antenna 151 that is contained in the display region in which the photograph data that has already been enlarged is displayed, and (ii) the photograph data displayed in the enlarged display size overlaps the another photograph data, the image adjusting section 24 reduces the enlarged display size until the two requirements (described earlier) are met.

Finally, the display control section 22 displays the specified photograph data in an enlarged view (S100). Specifically, the image adjusting section 24 enlarges the photograph data 171 in a post-change enlarged display size. Then, the display control section 22 displays, at the display position determined by the image adjusting section 24, enlarged photograph data (the photograph data 171A illustrated in (b) of FIG. 11). Then, the display control section 22 determines whether photograph data can further be arranged (S101). In a case where the display control section 22 determines that photograph data can further be arranged (YES in S101), the photograph display process returns to the step S92. Meanwhile, in a case where the display control section 22 determines that photograph data cannot further be arranged (NO in S101), the photograph display process is ended.

Note that a process carried out in response to a touch on the reduction button 193 corresponds to the above process carried out in response to a touch on the enlargement button 192. That is, in a case where photograph data is to be reduced (for example, in a case where the reduction button 193 has been touched in the state illustrated in (b) of FIG. 11), a reduced display size of the photograph data is changed so that a display region in which the photograph data displayed in the reduced display size is displayed contains at least one antenna 150 and does not contain another antenna 151 that is contained in a display region in which photograph data that has already been reduced is displayed. Specifically, photograph data is displayed as illustrated in (a) of FIG. 11.

Further, in a case where near field communication is not carried out, i.e., in a case where photograph data is displayed only for browsing, it is possible to display all the sets of photograph data at a predetermined enlargement ratio without the need to carry out the above process. It is only necessary that in accordance with touch information generated by a user operation, the application executing section 21 switch between a mode in which near field communication is carried out and a mode in which near field communication is not carried out.

Further, the antenna specifying section 23 which has acquired positional information of an antenna 150 can cause the antenna state determining section 27 to determine whether the antenna 150 is in the state communication-enabled state. Note that, in the example shown in FIG. 12, photograph data is enlarged or reduced in a state in which an antenna 150 in the communication-enabled state is entirely contained in each of display regions in which respective sets of photograph data are displayed. Thus, it has already been determined whether each antenna 150 is in the communication-enabled state. Therefore, the example shown in FIG. 12 omits such determination.

### Embodiment 4

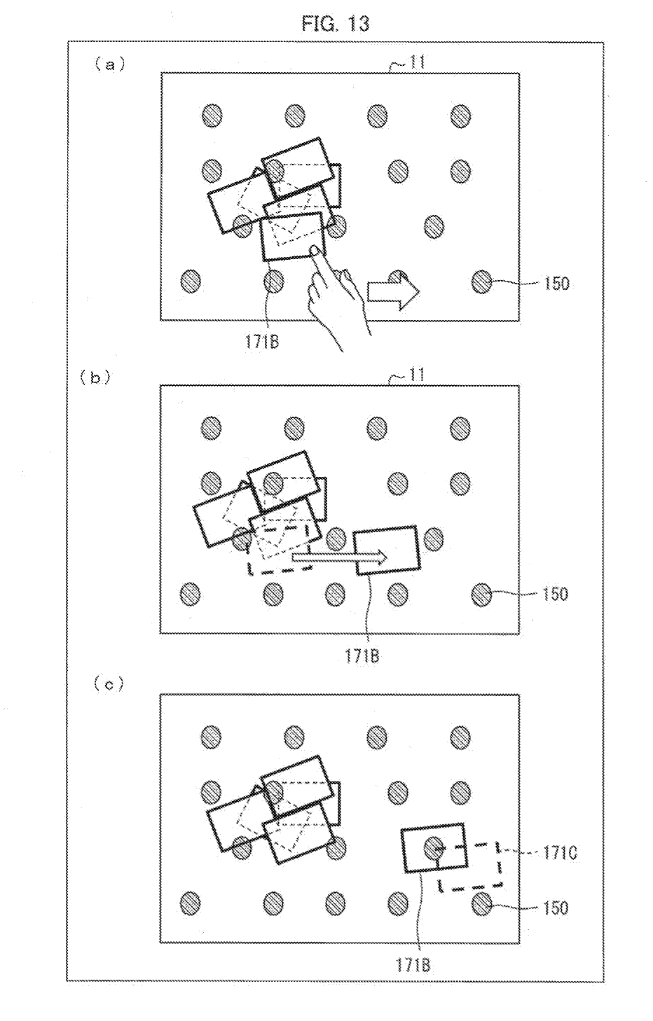

The following description discusses a further embodiment of the present invention with reference to FIGS. 13 through 15. Note that, for convenience of explanation, identical reference numerals are given to constituent members having functions identical with those of the constituent members described in Embodiments 1 to 3, and descriptions of such constituent members are omitted here.

(Specific Example of Process in Accordance with Embodiment 4)

First, the following description discusses a specific example of a process in accordance with Embodiment 4 with reference to FIG. 13. FIG. 13 is a transition diagram showing an example of a flow of a process carried out by the information processing device 1 of Embodiment 4.

In Embodiment 4, as illustrated in (a) of FIG. 13, a plurality of sets of photograph data possessed by a first user is arranged so as to overlap each other. A user can carry out a touch operation (specifically, a flick operation or a dragging operation) with respect to the sets of photograph data so as to move and relocate each of the overlapped sets of photograph data to a position desired by the user. In so doing, each of the sets of photograph data is relocated to a position at which a display region in which each of the sets of photograph data is displayed contains at least one antenna and does not contain another antenna 151 that is contained in a display region in which photograph data that has already been relocated is displayed.

Specifically, in a case where a flick operation is carried out with respect to photograph data 171B as illustrated in (a) of FIG. 13, the photograph data 171B moves as illustrated in (b) of FIG. 13. In this case, the image adjusting section 24 calculates a relocation position to which the photograph data 171B is relocated (specifically, 171C illustrated in (c) of FIG. 13). Subsequently, the image adjusting section 24 instructs the antenna specifying section 23 to specify an antenna 150 closest to the relocation position thus calculated. The antenna specifying section 23 supplies positional information of the specified antenna 150 to the image adjusting section 24.

The image adjusting section 24 determines a position at which the photograph data 171B is arranged so as to contain the antenna 150 indicated by the supplied positional information. Then, as illustrated in (c) of FIG. 13, the display control section 22 relocates the photograph data 171B to the position determined by the image adjusting section 24.

With this arrangement, in a case where the user merely carries out a flick operation, photograph data is automatically relocated to a position at which the photograph data contains at least one antenna 150. That is, it is unnecessary for the user to make fine adjustments so that a relocation position to which photograph data is relocated is set to a position at which the photograph data contains at least one antenna 150. Thus, it is possible to relocate, by a simple operation, photograph data to a position at which near field communication can be carried out.

(Flow of Process in Accordance with Embodiment 4)

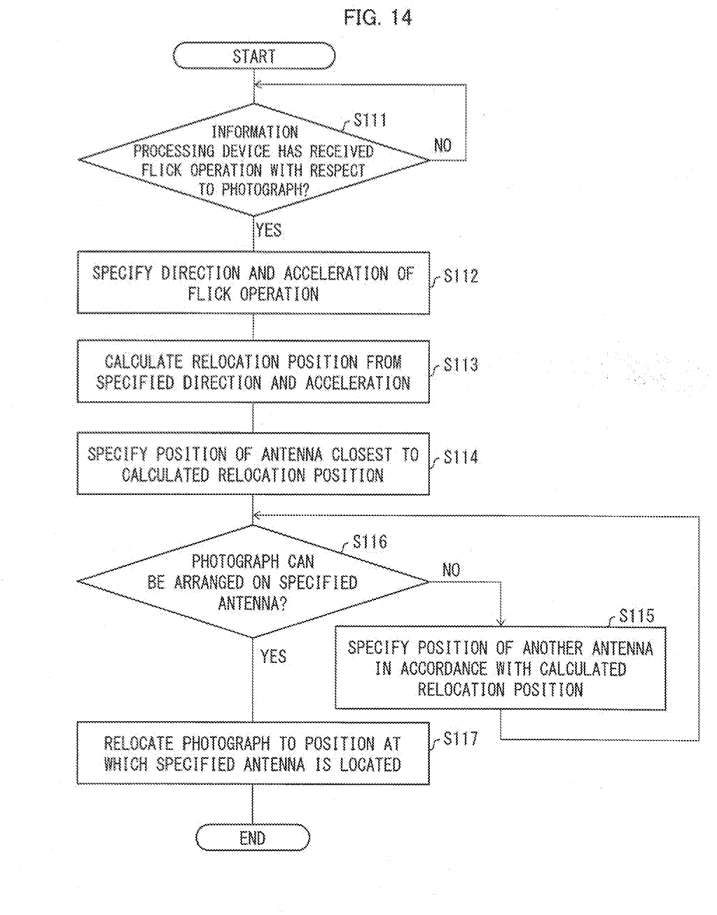

Next, a flow of a process in accordance with Embodiment 4 is described below with reference to FIG. 14. FIG. 14 is a flowchart showing a flow of a process in accordance with Embodiment 4. Note that in Embodiment 4, a process in which near field communication is carried out between the smartphone 10 and the information processing device 1 is similar to the process illustrated in FIG. 4, which has been described in Embodiment 1. Therefore, FIG. 14 omits a description of the process for carrying out near field communication.

First, the application executing section 21 of the information processing device 1 is in a state of waiting to receive, via the input section 17 of the display device 11, touch information indicative of a position at which the user carries out a touch operation (S111). Note here that the application executing section 21 which has received a flick operation carried out with respect to photograph data (YES in S111), specifically, the application executing section 21 which has acquired touch information indicative of a flick operation carried out with respect to the photograph data specifies a direction of the flick operation and an acceleration of the flick operation (S112). Then, the application executing section 21 supplies information on the specified direction and the specified acceleration to the display control section 22 (specifically, the image adjusting section 24).

The image adjusting section 24 calculates a relocation position from the specified direction and the specified acceleration (S113). Then, the image adjusting section 24 supplies, to the antenna specifying section 23, information indicative of the relocation position thus calculated.

The antenna specifying section 23 specifies a position of an antenna 150 that is closest to the calculated relocation position (S114). Specifically, with reference to the antenna position information and the information indicative of the relocation position, the antenna specifying section 23 specifies the position of the antenna 150 that is closest to the relocation position, and acquires positional information of the antenna 150.

Subsequently, it is determined whether photograph data can be arranged on the specified antenna 150 (S116). Specifically, first, the antenna specifying section 23 causes the antenna state determining section 27 to determine whether the antenna 150 whose positional information has been acquired is in the communication-enabled state. In a case where a result of the determination shows that the antenna 150 whose positional information has been acquired is in the communication-enabled state, the antenna specifying section 23 supplies positional information of the specified antenna 150 to the image adjusting section 24. With reference to arrangement information of photograph data, the image adjusting section 24 determines whether another photograph data is arranged at the position indicated by the supplied positional information. In a case where a result of the determination shows that another photograph data is not arranged at the position indicated by the supplied positional information, the image adjusting section 24 further determines, with reference to arrangement information of photograph data, whether the photograph data which is arranged at the position indicated by the supplied positional information overlaps at least a part of a display region in which another photograph data arranged around the photograph data is displayed. In a case where a result of the determination shows that such overlap does not occur, the image adjusting section 24 determines that photograph data can be arranged on the specified antenna 150.

In a case where the image adjusting section 24 determines that photograph data can be arranged on the specified antenna 150 (YES in S116), the display control section 22 relocates the photograph data to the position at which the specified antenna 150 is located (S 117). Specifically, the display control section 22 relocates the photograph data so that the photograph data contains the antenna 150 specified by the antenna specifying section 23. Then, a relocation process is ended.

Meanwhile, in a case where (i) the result of the determination by the antenna state determining section 27 shows that the antenna 150 whose positional information has been acquired is not in the communication-enabled state, (ii) the result of the determination by the image adjusting section 24 shows that another photograph data is arranged at the position indicated by the supplied positional information, or (iii) the photograph data arranged at the position indicated by the supplied positional information overlaps at least a part of the display region in which another photograph data arranged around the photograph data is displayed, the image adjusting section 24 determines that no photograph data can be arranged on the specified antenna 150. Then, the image adjusting section 24 supplies, to the antenna specifying section 23, information indicating that no photograph data can be arranged on the specified antenna 150.

In response to the information indicating that no photograph data can be arranged on the specified antenna 150, the antenna specifying section 23 specifies a position of another antenna 150 in accordance with the calculated relocation position (S115). Specifically, the antenna specifying section 23 specifies an antenna 150 that is second closest to the calculated relocation position, and acquires positional information of the antenna 150 that is second closest. Then, the step S116 is carried out again.

(Variations of Embodiment 4)

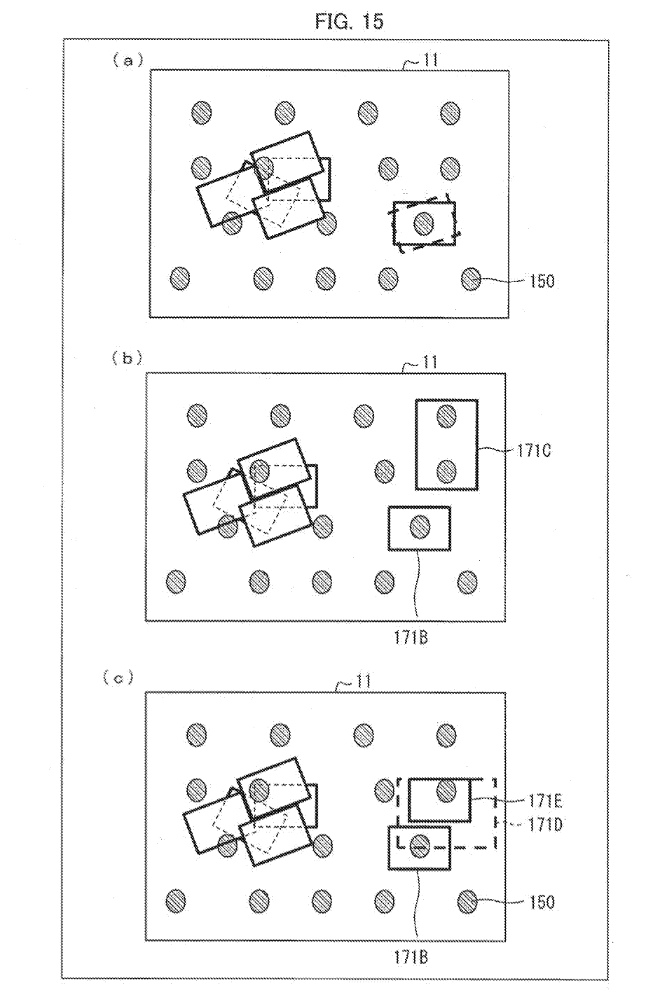

Next, the following description discusses variations of Embodiment 4 with reference to FIG. 15. FIG. 15 is a screen view showing another example of Embodiment 4.

First, according to Embodiment 4, in a case where a plurality of sets of photograph data is initially displayed so as to overlap each other, the sets of photograph data may be displayed in a state in which an orientation of each of the sets of photograph data is different from its intended orientation. Furthermore, in Embodiment 4, an initial orientation of photograph data being displayed is maintained after the photograph data is relocated to another position. Note, however, that the image adjusting section 24 can change an orientation of photograph data relocated to another position. Specifically, the image adjusting section 24 specifies image information of photograph data to be relocated and specifies an intended orientation of the photograph data from the image information thus specified. Then, as illustrated in (a) of FIG. 15, the image adjusting section 24 changes the orientation of the relocated photograph data to the intended orientation. That is, in this variation, the image information contains information indicative of respective intended orientations of sets of photograph data.

Further, a size of photograph data is not limited to a specific size. For example, as illustrated in (b) of FIG. 15, photograph data 171C, which is larger in size than the photograph data 171B, can be present. As illustrated in (b) of FIG. 15, the photograph data 171C can be relocated so that a display region in which the photograph data 171C is displayed entirely contains a plurality of antennas 150.

Moreover, as a result of relocation of photograph data, as illustrated in (c) of FIG. 15, an antenna 150 contained in a display region in which photograph data that has already been relocated (specifically, the photograph data 171B) is displayed may be contained in a display region in which another photograph data (photograph data 171D illustrated in (c) of FIG. 15) is displayed. Therefore, the following arrangement is preferably employed. That is, the image adjusting section 24 determines whether a display region in which relocated photograph data is displayed contains another antenna that is contained in a display region in which photograph data that has already been relocated is displayed. In a case where the image adjusting section 24 determines that the display region in which the relocated photograph data is displayed contains another antenna that is contained in the display region in which the photograph data that has already been relocated is displayed, the image adjusting section 24 preferably changes the size of the relocated photograph data. Specifically, with reference to the antenna position information 32, the image adjusting section 24 reduces the size of the relocated photograph data until the display region in which the relocated photograph data is displayed contains no other antenna that is contained in the display region in which the photograph data that has already been relocated is displayed. For example, the photograph data 171D illustrated in (c) of FIG. 15 is reduced in size and then displayed as photograph data 171E. This makes it possible to accurately specify an antenna 150 that corresponds to photograph data.

Note that, in a case where near field communication is not carried out, i.e., in a case where photograph data is displayed only for browsing, without the need to carry out the above process , it is possible to display photograph data at a relocation position calculated by the image adjusting section 24. It is only necessary that in accordance with touch information generated by a user operation, the application executing section 21 switch between a mode in which near field communication is carried out and a mode in which near field communication is not carried out.

### Embodiment 5

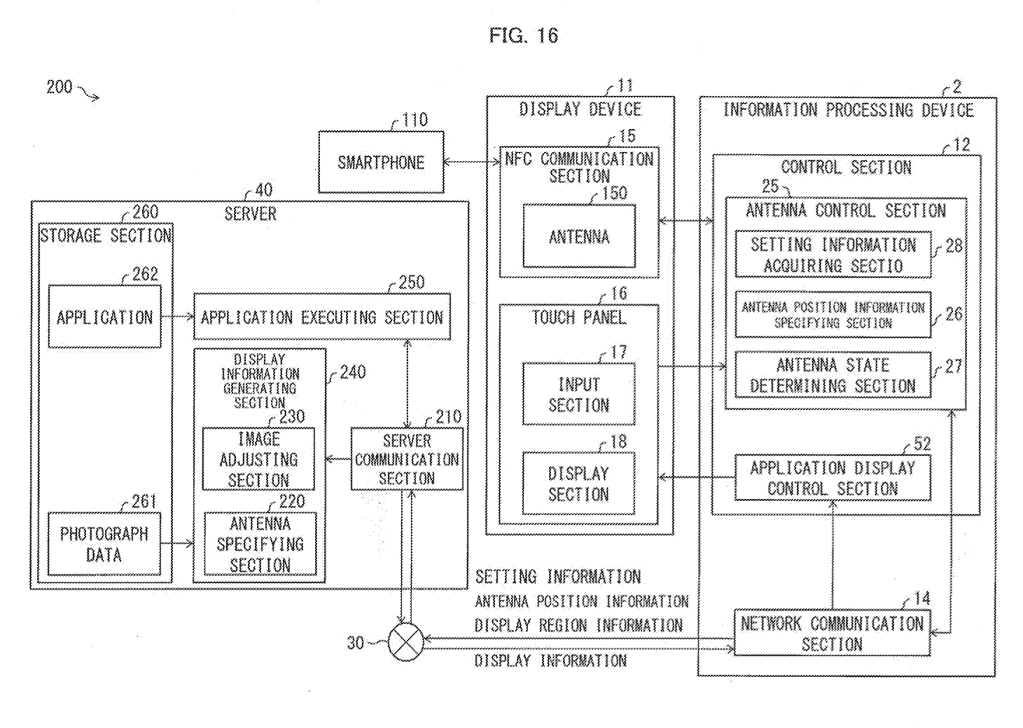

The following description discusses a further embodiment of the present invention with reference to FIGS. 16 through 18. Note that, for convenience of explanation, identical reference numerals are given to constituent members having functions identical with those of the constituent members described in Embodiments 1 to 4, and descriptions of such constituent members are omitted here.

According to Embodiments 1 to 4 described earlier, the information processing device 1 carries out a process for adjusting at least one of a position, a size, and an orientation of photograph data and at least one of a position, a size, and an orientation of each of the items of menu image. In contrast, Embodiment 5 discusses an example arrangement in which such an adjustment process is carried out by a server 40 (display control device).

(Image Display System 200)

First, an image display system 200 is described with reference to FIG. 16. FIG. 16 is a block diagram showing an example of an arrangement of a main part of each of an information processing device 2, a display device 11, and a server 40 which are included in the image display system 200.

Unlike the information processing device 1, the information processing device 2 includes neither the application executing section 21 nor the display control section 22. Besides, the information processing device 2 newly includes an application display control section 52.

The application display control section 52 displays an image related to an application. Specifically, in a case where the application display control section 52, in response to execution of an application 262 by the server 40, receives, from the server 40, display information (e.g., a script) for displaying an image, the application display control section 52 generates an image in accordance with the display information thus received, and then causes the display section 18 of the display device 11 to display the image thus generated.

Further, the antenna control section 25 carries out a process related to an antenna and transmits, to the server 40, a result of the process thus carried out. Specifically, in a case where the setting information acquiring section 28 receives setting information (specifically, first setting information) from a smartphone 10A, the antenna position information specifying section 26 generates antenna position information and then transmits, to the server 40, the generated antenna position information in addition to display region information indicative of a display region of the display section 18. The antenna state determining section 27 determines whether an antenna 150 which is indicated by the positional information supplied from the server 40 is in the communication-enabled state, and then transmits a result of the determination to the server 40. Further, the setting information acquiring section 28 to which information (specifically, setting information) acquired from the NFC tag 110 has been supplied from the NFC communication section 15 transmits, to the server 40, not only the setting information but also position information of an antenna 150 via which the setting information has been acquired.

As described earlier, the information processing device 2 has (i) a function of carrying out the process related to an antenna and then transmitting, to the server 40, a result of the process thus carried out and (ii) a function of generating an image corresponding to display information transmitted from the server 40 and causing the display section 18 to display the image thus generated.

As illustrated in FIG. 1, the server 40 is connected to the information processing device 2 via an Internet network 30 so that the server 40 and the information processing device 2 can communicate with each other. An arrangement of a main part of the server 40 will be described later.

Since the display device 11 and the smartphone 10 are similar to those described in Embodiment 1, and a description thereof is omitted below.

(Arrangement of Main Part of Server 40)

The server 40 includes a server communication section 210, a display information generating section 240 (display control section), an application executing section 250, and a storage section 260.

The server communication section 210 is a communication device for allowing transmission and reception of information to be carried out between the server 40 and an external device (for example, the information processing device 2) via the Internet network 30.

The display information generating section 240 generates display information for causing the display device 11 to display an image. The display information generating section 240 includes an antenna specifying section 220 and an image adjusting section 230. The display information generating section 240 which has received the antenna position information and the display region information from the information processing device 2 reads a plurality of sets of photograph data 261 (described later) from the storage section 260 and then selects one of the plurality of sets of photograph data 261.

The antenna specifying section 220 is identical in basic function to the antenna specifying section 23 described in Embodiment 1. Thus, a specific description of the antenna specifying section 220 is omitted here. The antenna specifying section 220 transmits, to the information processing device 2, an instruction to determine whether a specified antenna 150 is in the communication-enabled state, and causes the antenna state determining section 27 to carry out the determination.

The image adjusting section 230 is identical in basic function to the image adjusting section 24 described in Embodiment 1. Thus, a specific description of the image adjusting section 230 is omitted here.

With reference to a display position and a display size of the selected photograph data 261, the display position and the display size each having been determined by the image adjusting section 230, the display information generating section 240 generates display information of the specified photograph data 261. The display information generating section 240 which has finished carrying out the above process with respect to all the sets of photograph data 261 transmits the generated display information to the information processing device 2.

The application executing section 250 is identical in basic function to the application executing section 21 described in Embodiment 1. Thus, a specific description of the application executing section 250 is omitted here. The application executing section 250 which has received various pieces of information (touch information, setting information, etc.) from the information processing device 2 instructs the display information generating section 240 to generate display information of an image in accordance with the pieces of information thus received. For example, the application executing section 250 which has received the first setting information instructs the display information generating section 240 to generate display information for causing the display device 11 to display a list of the photograph data 261.

(Flow of Process in Accordance with Embodiment 5)

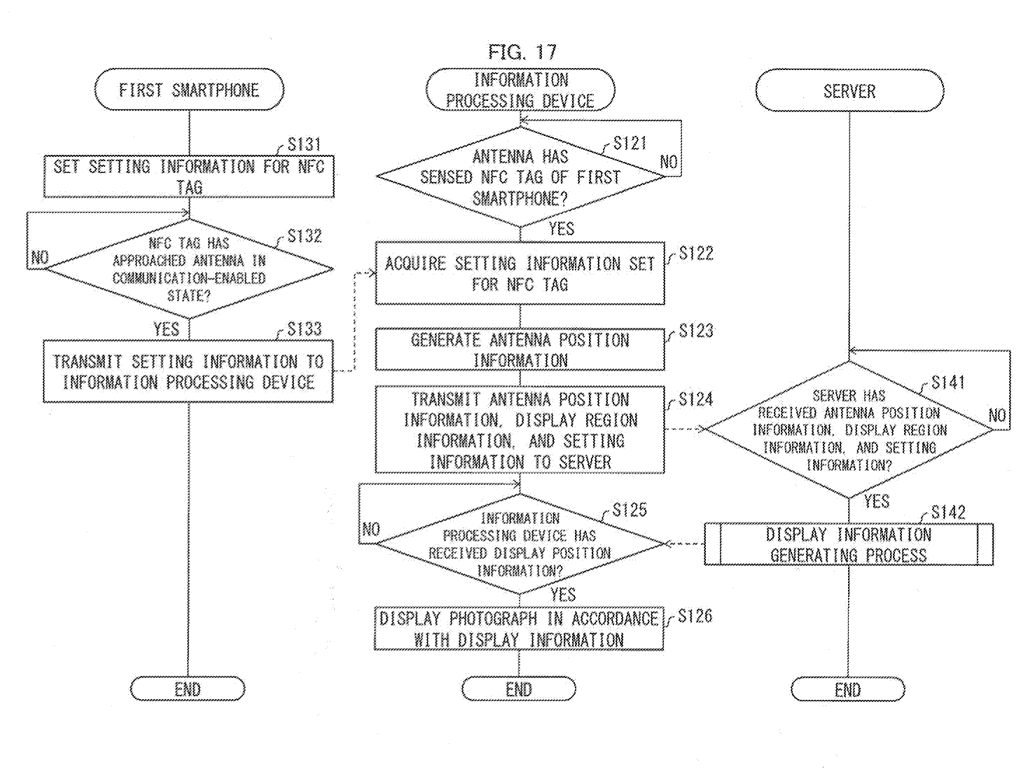

Next, a flow of a process in accordance with Embodiment 5 is described below with reference to FIG. 17. FIG. 17 is a flowchart showing a flow of a process in accordance with Embodiment 5. Note that since FIG. 17 shows a flow of a process for displaying a list of photograph data in the display device 11, FIG. 17 omits a description of a process related to near field communication with the smartphone 10B.

First, the first user sets the first setting information for the NFC tag 110 of the smartphone 10A of the first user (S131). Specifically, in accordance with an instruction from the application executing section 130, the information setting section 120 sets, for the NFC tag 110, information indicative of the account of the first user in the on-line storage service operated by the operator by use of the server 20. This allows the NFC tag 110 to be capable of transmitting the first setting information by approaching an antenna 150 (S132).

Meanwhile, the application executing section 250 of the server 40 transmits, to the antenna control section 25, an instruction to cause all the antennas 150 of the display device 11 to be in the communication-enabled state (S121). In a case where the NFC tag 110 of the smartphone 10A approaches an antenna 150 which is in the communication-enabled state (YES in S132) and the antenna 150 senses the NFC tag 110 (YES in S121), the first setting information is transmitted from the NFC tag 110 to the information processing device 2 via the antenna 150 (S133). Specifically, the NFC communication section 15 which has acquired the first setting information via the antenna 150 which is in the communication-enabled state transmits the first setting information to the antenna control section 25 (the setting information acquiring section 28). The setting information acquiring section 28 which has acquired the first setting information (S122) instructs the antenna position information specifying section 26 to generate antenna position information (S123). Then, the antenna control section 25 transmits, to the server 40, the received first setting information, the antenna position information, and the display region information of the display section 18 (S124).

The server communication section 210 which has received the first setting information, the antenna position information, and the display region information (S141) supplies the first setting information to the application executing section 250 and supplies the antenna position information and the display region information to the display information generating section 240. Then, a display information generating process is carried out (S142). Note that the display information generating process will be specifically described later.

As a result of the display information generating process carried out, the information processing device 2 receives display information from the server 40 (YES in S125). Then, the application display control section 52 causes the display device 11 to display photograph data in accordance with the received display information (S126). Specifically, the application display control section 52 causes the display device 11 to display photograph data at a position defined by the received display information and in a size defined by the received display information.

(Flow of Display Information Generating Process)

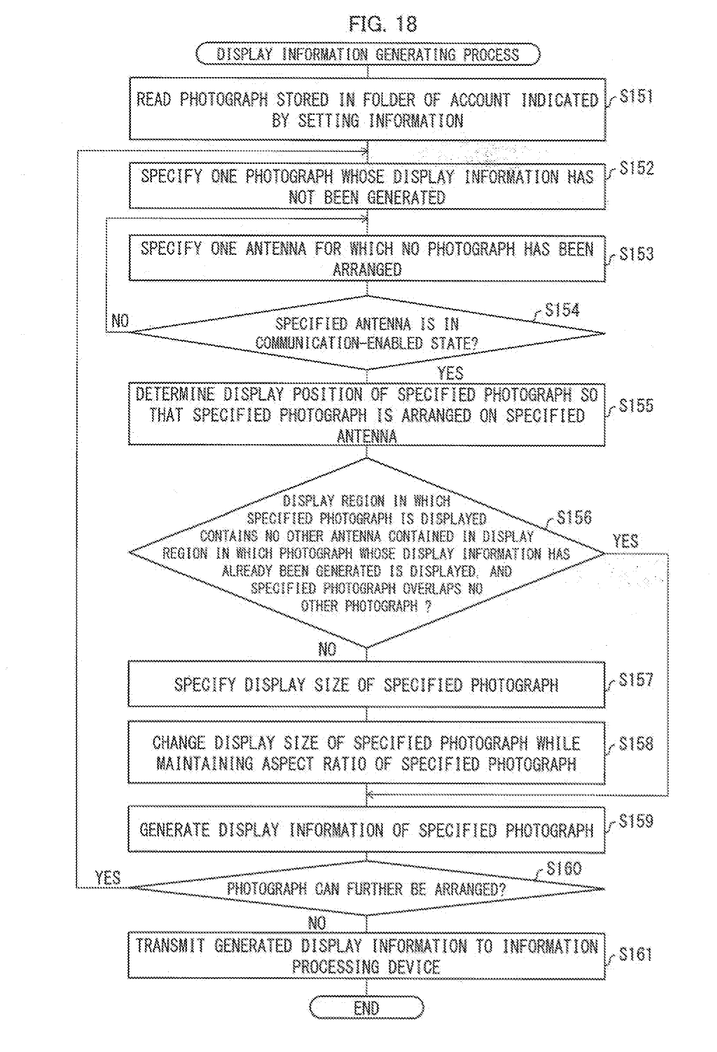

Next, a flow of the display information generating process illustrated in FIG. 17 is described below with reference to FIG. 18. FIG. 18 is a flowchart showing an example of a flow of the display information generating process illustrated in FIG. 17.

First, the application executing section 250 which has received the first setting information instructs the display information generating section 240 to generate display information for causing the display device 11 to display a list of photograph data 261. Specifically, the application executing section 250 specifies the account of the first user in the on-line storage service operated by the operator by use of the server 40, and modifies the first setting information so as to carry out a process for displaying a list of a plurality of sets of photograph data 261 stored by the first user in a folder. Then, in accordance with the modified first setting information, the application executing section 250 instructs the display information generating section 240 to generate display information for causing the display device 11 to display the list of photograph data 261.

Subsequently, in response to the instruction, the display information generating section 240 reads all the sets of photograph data 261 stored in the folder of the account indicated by the setting information (S151). Then, the display information generating section 240 specifies (selects), from the sets of photograph data 261 thus read, one set of photograph data 261 display information of which one set has not been generated (S152).

Then, the antenna specifying section 220 specifies one antenna 150 for which no photograph data 261 has been arranged (S153). Specifically, with reference to the received antenna position information 32, the antenna specifying section 220 acquires positional information of an antenna 150 that is not contained in a display region in which photograph data 261 whose display position has already been determined is displayed.

Thereafter, the antenna specifying section 220 transmits, to the information processing device 2, the acquired positional information of the antenna 150 and causes the antenna state determining section 27 to determine whether the antenna 150 is in the communication-enabled state (S154). In a case where a result of the determination shows that the antenna 150 is not in the communication-enabled state (NO in S154), the antenna specifying section 220 carries out the step S153 again so as to acquire positional information of another antenna 150.

Meanwhile, in a case where the result of the determination shows that the antenna 150 is in the communication-enabled state (YES in S154), the antenna specifying section 220 supplies, to the image adjusting section 230, positional information of an antenna 150 which has been specified (whose positional information has been acquired). Subsequently, in order that photograph data 261 specified by the display information generating section 240 is arranged on the specified antenna 150, the image adjusting section 230 determines a display position of the photograph data 261 (S155). Specifically, in order that a display region in which selected photograph data 261 is displayed contains an antenna 150 indicated by the supplied positional information, the image adjusting section 230 determines a display position of the selected photograph data 261.

Then, the image adjusting section 230 determines (i) whether a display region in which specified photograph data 261 is displayed contains another antenna 151 that is contained in a display region in which photograph data whose display information has already been generated is displayed, and (ii) whether the specified photograph data 261 overlaps another photograph data (S156). Specifically, with reference to the antenna position information, the image adjusting section 230 determines whether a display region in which selected photograph data 261 is displayed contains another antenna 151 that is contained in a display region in which photograph data whose display information has already been generated is displayed. Further, with reference to arrangement information of photograph data 261 (specifically, display information of another photograph data), the image adjusting section 230 determines whether at least a part of the display region in which the selected photograph data 261 is displayed coincides with a display region in which another photograph data is displayed.

In a case where the image adjusting section 230 determines (i) that the display region in which the specified photograph data 261 is displayed contains no other antenna 151 that is contained in the display region in which the photograph data whose display information has already been generated is displayed, and (ii) that the specified photograph data 261 overlaps no other photograph data (YES in S156), the display information generating section 240 generates display information of the specified photograph data 261 (S159). Specifically, with reference to the received display region information, the display information generating section 240 generates display information for causing the selected photograph data 261 to be displayed at a position determined by the image adjusting section 230. Then, the display information generating section 240 determines whether photograph data 261 can further be arranged (S160). In a case where the display information generating section 240 determines that photograph data 261 can further be arranged (YES in S160), the display information generating process returns to the step S152. Meanwhile, in a case where the display information generating section 240 determines that photograph data 261 cannot be arranged (NO in S160), the generated display information is transmitted to the information processing device 2 (S161). The display information generating process is thus ended.

In contrast, in a case where the image adjusting section 230 determines (i) that the display region in which the specified photograph data 261 is displayed contains another antenna 151 that is contained in the display region in which the photograph data whose display information has already been generated is displayed, or (ii) that the specified photograph data 261 overlaps the another photograph data (NO in S156), the image adjusting section 230 specifies a display size of the specified photograph data 261 (S157). Specifically, the image adjusting section 230 specifies image information of selected photograph data 261 and acquires size information of the selected photograph data 261. Then, the image adjusting section 230 changes the display size of the specified photograph data 261 while maintaining an aspect ratio of the specified photograph data 261 (S158). Specifically, in a case where a display region in which the selected photograph data 261 is displayed contains the another antenna 151 that is contained in the display region in which the photograph data whose display information has already been generated is displayed, with reference to the received antenna position information, the image adjusting section 230 reduces the selected photograph data 261 until the display region in which the selected photograph data 261 is displayed contains no other antenna 151 that is contained in the display region in which the photograph data whose display information has already been generated is displayed. Meanwhile, in a case where the selected photograph data 261 overlaps the another photograph data, with reference to display regions in which the selected photograph data 261 and the another photograph data, respectively, are displayed, the image adjusting section 230 reduces the selected photograph data 261 until the display regions do not overlap with each other. Note that in a case where (i) an edge of the selected photograph data 261 overlaps the another antenna 151, and (ii) the selected photograph data 261 overlaps the another photograph data, the image adjusting section 230 reduces the selected photograph data until the two requirements (described earlier) are met.

Finally, the display information generating section 240 generates display information of the specified photograph data 261 (S159). Specifically, with reference to the received display region information, the display information generating section 240 generates display information for causing the selected photograph data 261 (specifically, reduced photograph data 261) to be displayed at a position determined by the image adjusting section 230. Then, the display information generating section 240 determines whether photograph data 261 can further be arranged. In a case where the display information generating section 240 determines that photograph data 261 can further be arranged (YES in S160), the display information generating process returns to the step S152. Meanwhile, in a case where the display information generating section 240 determines that photograph data 261 cannot be arranged (NO in S160), the generated display information is transmitted to the information processing device 2 (S161). The photograph display process is thus ended.

[Variations Shared by Embodiments 1 through 5]

The following description discusses variations shared by Embodiments 1 through 5.

With reference to information indicative of a display position of an image which display position has been determined by the image adjusting section 24 (or the image adjusting section 230), the antenna control section 25 can cause an antenna 150 that is contained in a display region in which the image is displayed to be in the communication-enabled state, and can cause the other antennas 150 (antennas 150 none of which are entirely contained in the display region in which the image is displayed) to be in the communication-disabled state. This makes it possible to further prevent near field communication that is not desired by a user from being carried out.

Further, with reference to information indicative of a display position of an image which display position has been determined by the image adjusting section 24 (or the image adjusting section 230), the antenna control section 25 can cause only an antenna 150 that is entirely contained in a display region in which an image containing communication specifying information (such as a data tag) is displayed to be in the communication-enabled state. This allows an antenna 150 via which no near field communication is carried out to be in the communication-disabled state, and thus makes it possible to further prevent near field communication that is not desired by a user from being carried out.

According to the embodiments described earlier, an image is displayed so that an antenna 150 is contained in a display region in which the image is displayed. Note, however, that an antenna 150 does not need to be contained in a display region in which an image is displayed, provided that display regions in which respective images are displayed and antennas 150 are in one-to-one or one-to-N (N is an integer of not less than 1) correspondence.

Specifically, the NFC tag 110 measures radio field intensities supplied from the respective antennas 150, and near field communication is carried out between the NFC tag 110 and an antenna 150 that has the highest radio field intensity. That is, in a case where an image whose display region is located at a position that is closest to a certain antenna 150 is displayed at a position at which the image is designated as only one image, a process in accordance with the image is carried out when near field communication is carried out between the antenna 150 and the NFC tag 110.

More specifically, the image adjusting section 24 which has determined a display position of an image selected by the display control section 22 not only carries out the determination (described in, for example, Embodiment 1) but also measures a distance between the image and an antenna 150 whose positional information has been acquired (hereinafter, referred to as a first distance). The image adjusting section 24 also measures distances between the image selected by the display control section 22 and other antennas 151 that are contained in respective images that have already been arranged (hereinafter, referred to as second distances). In a case where the second distances include a second distance that is shorter than the first distance, a size of the image selected by the display control section 22 is reduced until all the second distances are made longer than the first distance. With the arrangement, also in a case where an image is displayed so that no antenna 150 is contained in a display region in which the image is displayed, near field communication that is desired by a user is carried out.

In this case, in order that an image to be displayed is not located at a position that is closest to an antenna 150 that is associated with an image that has already been arranged (an antenna 150 that is located at a position that is closest to an image that has already been arranged), the image adjusting section 24 determines a position of the image to be displayed. This prevents a plurality of images from being associated with one antenna 150.

Further, the embodiments described earlier each have discussed an arrangement in which the display device 11 includes the antennas 150 and the smartphone 10 includes the NFC tag 110. Meanwhile, the present invention is also applicable to an arrangement in which the display device 11 includes a plurality of tags for NFC and the smartphone 10 includes a tag reader.

### Embodiment 6

Embodiments 1 through 4 each have discussed an example in which one information processing device 1 is used. Note, however, that functions of the information processing device 1 can also be carried out by respective separate devices. For example, the information processing device 1 can include: an antenna information acquiring device for acquiring (i) antenna position information indicative of a position of an antenna 150 with respect to the display section 18 and (ii) antenna state information indicating whether communication can be carried out via each antenna, i.e., whether electric power is being supplied to the each antenna; and a display control device for executing an application and using the antenna position information and the antenna state information to cause the display device 11 to display an image serving as a result of the execution of the application.

Embodiment 5 has discussed an example in which one server 40 is used. Note, however, that functions of the server 40 can also be carried out by respective separate servers. For example, a display information generating server for generating display information and a photograph data managing server for managing photograph data 261 can be respective separate servers.

In a case where a plurality of servers is used, the plurality of servers can be managed by a single operator or can be managed by respective different operators.

### Embodiment 7

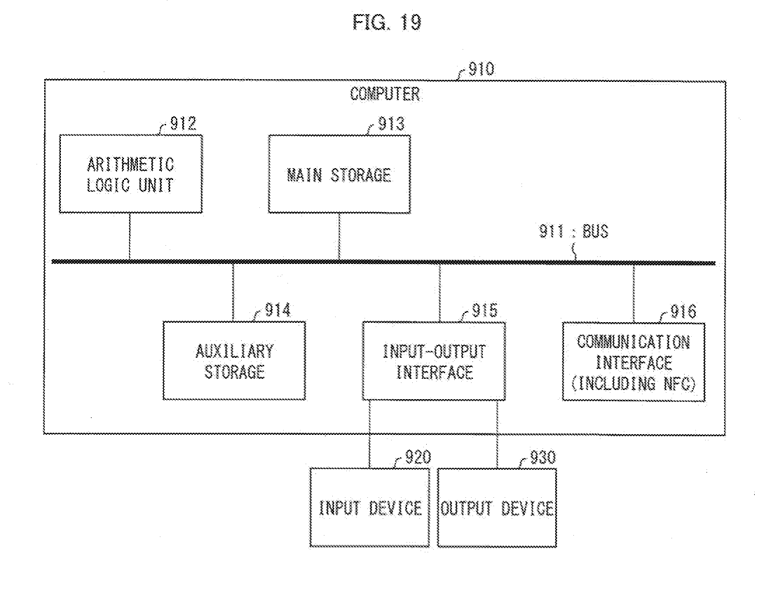

Blocks of each of information processing devices 1 and 2, a smartphone 10, and a server 20 can be realized by a logic circuit (hardware) provided in an integrated circuit (IC chip) or the like or can be alternatively realized by software as executed by a central processing unit (CPU). In the latter case, each of the information processing devices 1 and 2, the smartphone 10, and the server 20 can be configured with use of a computer (electronic calculator) as illustrated in FIG. 19.

FIG. 19 is a block diagram illustrating an example configuration of a computer 910 which is usable as each of the information processing devices 1 and 2, the smartphone 10, and the server 20. The computer 910 includes an arithmetic logic unit 912, a main storage 913, an auxiliary storage 914, an input-output interface 915, and a communication interface 916 which are connected to each other via a bus 911. Each of the arithmetic logic unit 912, the main storage 913, and the auxiliary storage 914 can be a CPU, a Random Access Memory (RAM), or a hard disk drive. The input-output interface 915 is connected with (i) an input device 920 via which a user (contractor) is to input various pieces of information into the computer 910 and (ii) an output device 930 via which the computer 910 is to output various pieces of information to the user. Each of the input device 920 and the output device 930 can be included in the computer 910 or can be connected to the computer 910 (externally attached to the computer 910). For example, the input device 920 can be a keyboard, a mouse, a touch sensor, or the like, and the output device 930 can be a display, a printer, a speaker, or the like. Alternatively, it is also possible to employ a device having both a function of the input device 920 and a function of the output device 930 (such as a touch panel obtained by integrating a touch sensor and a display). The communication interface 916 is an interface via which the computer 910 communicates with an external device. Note that the communication interface 916 includes a communication interface via which to carry out near field communication.

The auxiliary storage 914 stores therein various programs for causing the computer 910 to operate as each of the information processing devices 1 and 2, the smartphone 10, and the server 20. The arithmetic logic unit 912 loads, in the main storage 913, the various programs stored in the auxiliary storage 914, and executes a command included in each of the various programs so that the computer 910 functions as each section of the information processing devices 1 and 2, the smartphone 10, and the server 20. Note that a recording medium which the auxiliary storage 914 uses to record information, such as the various programs, only needs to be a computer-readable “non-transitory tangible medium.” Examples of the recording medium include tapes, disks, cards, semiconductor memories, and programmable logic circuits.

The various programs can be obtained from an outside of the computer 910. In this case, the various programs can be obtained via any transmission medium (such as a communication network or a broadcast wave). The present invention can also be achieved in the form of a computer data signal in which the various programs are embodied via electronic transmission and which is embedded in a carrier wave.

### Conclusion

A display control device (information processing device 1, server 40) in accordance with Aspect 1 of the present invention for causing a display device (11) including: a display section (18) for displaying one or more images; and a near field communication section (NFC communication section 15) placed on the display section and having a plurality of antennas (150) via which to externally carry out near field communication to display the one or more images in the display section, the display control device includes: a display control section (display control section 22, display information generating section 240) for causing each of the one or more images to be displayed in the display section at a position at which one of display regions in which the respective one or more images are displayed is designated to correspond to one of the plurality of antennas.

With the arrangement, each of the one or more images is displayed in the display section at a position at which one of display regions in which the respective one or more images are displayed is designated to correspond to one of the plurality of antennas. In other words, an image is not displayed at a position at which a display region in which the image is displayed is associated with an antenna that is associated with a display region in which another image is displayed.

With the arrangement, in a case where near field communication is carried out, one of the one or more images is designated to correspond to one of the plurality of antennas. This makes it possible to prevent communication that is not desired by a user.

Further, since an image is displayed in accordance with a position of an antenna, it is unnecessary to display, for example, an image indicative of a position of an antenna. This makes it possible to achieve an image display that is easily visible to a user.

Note here that a state in which “each of the one or more images is displayed in the display section at a position at which one of display regions in which the respective one or more images are displayed is designated to correspond to one of the plurality of antennas” includes a state in which only one image is displayed so as to be superimposed on one antenna and a state in which only one image is displayed at a position that is closest to one antenna.

In Aspect 2 of the present invention, the display control device can be arranged to further include: in Aspect 1 of the present invention, an image adjusting section (image adjusting section 24, image adjusting section 230) for adjusting at least one of a size, a position, and an orientation of the each of the one or more images in accordance with a position of each of the plurality of antennas.

With the arrangement, at least one of a size, a position, and an orientation of an image is adjusted in accordance with a position of an antenna.

With the arrangement, also in a case where a certain image is superimposed on an antenna on which another image is superimposed, it is possible to prevent the superimposition of the certain image on the antenna by changing a size, a position, and/or an orientation of the certain image. This makes it possible to designate one image to correspond to the antenna.

In Aspect 3 of the present invention, the display control device can be arranged such that in Aspect 2 of the present invention, in a case where the each of the one or more images is enlarged or reduced, the image adjusting section adjusts the at least one of the size, the position, and the orientation of the each of the one or more images each of which has been enlarged or reduced.

With the arrangement, in a case where a process for enlarging or reducing an image is carried out, at least one of a size, a position, and an orientation of the image is adjusted.

In a case where an image is enlarged or reduced, a certain image may be superimposed on an antenna on which another image is superimposed. Note, however, that also in such a case, the arrangement makes it possible to designate one image to correspond to the antenna.

In Aspect 4 of the present invention, the display control device can be arranged such that in Aspect 2 of the present invention, in a case where the each of the one or more images is relocated from its current position to another position, the image adjusting section adjusts the at least one of the size, the position, and the orientation of the each of the one or more images each of which has been relocated.

With the arrangement, in a case where a process for relocating an image is carried out, at least one of a size, a position, and an orientation of the image is adjusted.

In a case where an image is relocated, a certain image may be superimposed on an antenna on which another image is superimposed. Note, however, that also in such a case, the arrangement makes it possible to designate one image to correspond to the antenna.

In Aspect 5 of the present invention, the display control device can be arranged such that in any one of Aspects 1 through 4 of the present invention, the display control section prevents the each of the one or more images from being displayed so as to be superimposed on an antenna of the plurality of antennas which antenna is in a communication-disabled state in which it is impossible to carry out communication.

The arrangement prevents an image from being displayed so as to be superimposed on an antenna that is in the communication-disabled state.

Even in a case where a tag is brought into proximity to an antenna that is in the communication-disabled state, it is impossible to carry out near field communication. In a case where an image is superimposed on such an antenna, a user may misunderstand that it is possible to carry out communication in accordance with the image.

Note here that since the arrangement prevents an image from being displayed so as to be superimposed on an antenna that is in the communication-disabled state, it is possible to avoid causing misunderstanding to a user. Note that the communication-disabled state is a state in which it is impossible to carry out near field communication by use of an antenna. Note also that the communication-disabled state includes a state in which no electric power is supplied to an antenna (a communication-disabled state in respect of hardware), and a state in which electric power is supplied to an antenna but a function of near field communication carried out via the antenna is stopped (a communication-disabled state in respect of software).

In Aspect 6 of the present invention, the display control device can be arranged such that in any one of Aspects 1 through 5 of the present invention, the one or more images are respective pieces of content which pieces are contained in a content list that is displayed in the display section.

With the arrangement, an image is a piece of content which piece is contained in a content list. This makes it possible to designate one piece of content to correspond to an antenna. In other words, since there is no antenna that corresponds to a plurality of pieces of content, in a case where a user brings a tag into proximity to content that is desired by the user to be subjected to near field communication, a process as desired is carried out.

In Aspect 7 of the present invention, the display control device can be arranged such that in any one of Aspects 1 through 5 of the present invention, the one or more images are respective items that are shown in a menu image that is displayed in the display section.

With the arrangement, an image is an item that is shown in a menu image. This makes it possible to designate one item to correspond to an antenna. In other words, since there is no antenna that corresponds to a plurality of items, in a case where a user brings a tag into proximity to an item that is desired by the user to be subjected to near field communication, a process as desired is carried out.

Assume that the menu image has (i) item(s) that can be subjected to near field communication and (ii) item(s) that cannot be subjected to near field communication. In this case, by allowing only the item(s) that can be subjected to near field communication to be displayed so as to be superimposed on a corresponding antenna or respective different antennas, it is possible to display the menu image without the fear of seriously disarranging a layout of the menu image.

An image display system (100, 200) in accordance with Aspect 8 of the present invention includes: a display device including: a display section for displaying one or more images; and a near field communication section placed on the display section and having a plurality of antennas via which to externally carry out near field communication; and a display control device for causing the one or more images to be displayed in the display section of the display device, the display control device causing each of the one or more images to be displayed in the display section at a position at which one of display regions in which the respective one or more images are displayed is designated to correspond to one of the plurality of antennas.

The image display system has a working effect identical to that of the display control device in accordance with Aspect 1.

A method in accordance with Aspect 9 of the present invention for controlling a display control device for causing a display device including: a display section for displaying one or more images; and a near field communication section placed on the display section and having a plurality of antennas via which to externally carry out near field communication to display the one or more images in the display section; the method includes: a display control step (S39) of causing each of the one or more images to be displayed in the display section at a position at which one of display regions in which the respective one or more images are displayed is designated to correspond to one of the plurality of antennas.

The method has a working effect identical to that of the display control device in accordance with Aspect 1.

The display control device in accordance with the foregoing aspects of the present invention can be realized by a computer. In this case, the present invention encompasses: a control program for the display control device which program causes a computer to operate as the foregoing sections (limited to software elements) of the display control device so that the display control device can be realized by the computer; and a computer-readable recording medium in which the control program is recorded.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

(Another Expression of the Present Invention)

Note that the present invention can also be expressed as below.

A display control device in accordance with an aspect of the present invention for causing a display device including: a display section for displaying an image; and a near field communication section placed on the display section and having a plurality of antennas via which to externally carry out near field communication to display the image in the display section, the display control device includes: an image adjusting section for determining at least one of a display position and a size of the image so that (i) at least one of the plurality of antennas is entirely contained in a display region in which the image is displayed and (ii) a part of an antenna that is different from the at least one of the plurality of antennas, the at least one being entirely contained in the display region, is not contained in the display region.

The display control device in accordance with an aspect of the present invention can be arranged to further include: an antenna determining section (antenna specifying section 23, antenna specifying section 220) for determining an antenna that is entirely contained in the display region, the image adjusting section determining the at least one of the display position and the size of the image so that the antenna which has been determined by the antenna determining section is contained in the display region in which the image is displayed, and the antenna determining section not determining, as the antenna that is entirely contained in the display region, an antenna via which it is impossible to externally carry out near field communication.

The display control device in accordance with an aspect of the present invention can be arranged such that: the image is a defined image whose display state is defined by a script for displaying the image; and in a case where a part of an antenna is contained in a display region in which the defined image is displayed, the image adjusting section nullifies a size of the defined image which is defined by the script, and determines a size of the defined image.

The display control device in accordance with an aspect of the present invention can be arranged such that in a case where a part of an antenna is contained in a display region in which a specified image of the defined image with which specified image communication specifying information indicating that near field communication is carried out via the antenna is associated is displayed, the image adjusting section nullifies a size of the specified image which is defined by the script, and determines a size of the specified image.

The display control device in accordance with an aspect of the present invention can be arranged such that the image is an enlarged or reduced image obtained by causing a user operation with respect to an image displayed in the display section to enlarge or reduce the image displayed in the display section.

The display control device in accordance with an aspect of the present invention can be arranged such that the image is a relocated image obtained by causing a user operation with respect to an image displayed in the display section to move a position in the display section of the image displayed in the display section.

### INDUSTRIAL APPLICABILITY

The present invention is applicable to a display control device for causing a display device to display an image.

### REFERENCE SIGNS LIST

1 Information processing device (display control device)

11 Display device

15 NFC communication section (near field communication section)

18 Display section

22 Display control section

24 Image adjusting section

40 Server (display control device)

100 Image display system

150 Antenna

200 Image display system

230 Image adjusting section

240 Display information generating section (display control section)

S39 Display control step

1. A display control device for causing a display device including: a display section for displaying one or more images; and a near field communication section placed on the display section and having a plurality of antennas via which to externally carry out near field communication to display the one or more images in the display section,
said display control device comprising:
a display control section for causing each of the one or more images to be displayed in the display section at a position at which one of display regions in which the respective one or more images are displayed is designated to correspond to one of the plurality of antennas.

2. The display control device as set forth in claim 1, further comprising:
an image adjusting section for adjusting at least one of a size, a position, and an orientation of the each of the one or more images in accordance with a position of each of the plurality of antennas.

3. The display control device as set forth in claim 2, wherein in a case where the each of the one or more images is enlarged or reduced, the image adjusting section adjusts the at least one of the size, the position, and the orientation of the each of the one or more images each of which has been enlarged or reduced.

4. The display control device as set forth in claim 2, wherein in a case where the each of the one or more images is relocated from its current position to another position, the image adjusting section adjusts the at least one of the size, the position, and the orientation of the each of the one or more images each of which has been relocated.

5. The display control device as set forth in claim 1, wherein the display control section prevents the each of the one or more images from being displayed so as to be superimposed on an antenna of the plurality of antennas which antenna is in a communication-disabled state in which it is impossible to carry out communication.

6. The display control device as set forth in claim 1, wherein the one or more images are respective pieces of content which pieces are contained in a content list that is displayed in the display section.

7. The display control device as set forth in claim 1, wherein the one or more images are respective items that are shown in a menu image that is displayed in the display section.

8. An image display system comprising:
a display device including: a display section for displaying one or more images; and
a near field communication section placed on the display section and having a plurality of antennas via which to externally carry out near field communication; and
a display control device for causing the one or more images to be displayed in the display section of the display device,
the display control device causing each of the one or more images to be displayed in the display section at a position at which one of display regions in which the respective one or more images are displayed is designated to correspond to one of the plurality of antennas.

9. (canceled)

10. A method for controlling a display control device for causing a display device including: a display section for displaying one or more images; and a near field communication section placed on the display section and having a plurality of antennas via which to externally carry out near field communication to display the one or more images in the display section;
said method comprising:
a display control step of causing each of the one or more images to be displayed in the display section at a position at which one of display regions in which the respective one or more images are displayed is designated to correspond to one of the plurality of antennas.
